(19) United States
(12) Patent Application Publication
(10) Pub. No.: US 2002/0155847 A1
(43) Pub. Date: Oct. 24, 2002

(54) Communications recording system

(76) Inventors: Uri Weinberg, Tel-Aviv (IL); Avner Divon, Rosh-Hahayn (IL)

Correspondence Address: AVNER DIVON, 5 GEFEN ST., P.O. Box 4660, ROSH-HAHAYN, 48570, IL

(21) Appl. No.: 10/061,034

(22) Filed: Feb. 1, 2002

Related U.S. Application Data
(60) Provisional application No. 60/267,553, filed on Feb. 9, 2001.

(51) Int. Cl. H04Q 7/20

(52) U.S. Cl. 455/456; 455/435; 455/433

(57) ABSTRACT

A communications system and methodology for providing improved and enhanced mobile phone call recording, storing and retrieving services to subscribers. Multiple disparate communication recorders and storage facilities, preferably located at communications network switching centers, provides selected call recording services to subscribers according to pre-selected criteria provided by said subscribers before or during said call to be recorded. The system architecture of the present invention enables optimized solution for providing recording services to large number of subscribers by utilizing large-scale traffic monitoring and filtering techniques, distributed call recording and storage that minimizes superfluous traffic within said communications network and centralized retrieval center operative to locate and retrieve recorded calls to subscribers. In addition, the system provides cross-network roaming and unified recording services, including public line/IP/mobile networks and private exchanges. It can also interact with communicator-based recorders.

This application is based on provisional application No. 60/267,553 filed on Feb. 9, 2001.

### FIELD OF THE INVENTION

The present invention relates to recording of telephone communications generally.

### BACKGROUND OF THE INVENTION

The following U.S. patents are believed to represent the current state of the art:

| | | | |
|---|---|---|---|
| 4,875,229 | 10/1989 | Palett et al. | 455/550 |
| 5,003,574 | 3/1991 | Deng et al. | 379/75 |
| 5,303,296 | 4/1994 | Zucker | 379/067.1 |
| 5,309,434 | 5/1994 | Maekawa | 370/265 |
| 5,317,628 | 5/1994 | Misholi et al. | 379/088.14 |
| 5,335,266 | 8/1994 | Richardson et al. | 379/088.26 |
| 5,400,393 | 3/1995 | Knuth et al. | 379/88 |
| 5,471,519 | 11/1995 | Howe et al. | 379/088.26 |
| 5,506,888 | 4/1996 | Hayes et al. | 455/445 |
| 5,535,261 | 7/1996 | Brown et al. | 379/088.11 |
| 5,544,231 | 8/1996 | Cho | 379/088.24 |
| 5,548,636 | 8/1996 | Bannister et al. | 379/201 |
| 5,590,171 | 12/1996 | Howe et al. | 379/033 |
| 5,619,556 | 4/1997 | Richardson et al. | 379/088.22 |
| 5,740,543 | 4/1998 | Maeda | 455/550 |
| 5,752,188 | 5/1998 | Astrom et al. | 455/433 |
| 5,758,279 | 5/1998 | Foti | 455/412 |
| 5,757,889 | 5/1998 | Ohtake | 379/034 |
| 5,790,957 | 8/1998 | Heidari | 455/553 |
| 5,790,635 | 8/1998 | Dezonno | 379/034 |
| 5,867,793 | 2/1999 | Davis | 455/556 |
| 5,923,744 | 7/1999 | Cheng | 379/207 |
| 5,923,746 | 7/1999 | Baker et al. | 379/265 |
| 5,926,524 | 7/1999 | Taylor | 379/088.08 |
| 5,940,751 | 8/1999 | Kaplan et al. | 455/411 |
| 5,937,029 | 8/1999 | Yosef et al. | 379/001 |
| 5,937,056 | 8/1999 | Coyne et al. | 379/221 |
| 5,937,345 | 8/1999 | McGowan et al. | 455/410 |
| 5,953,655 | 9/1999 | Oiwa | 455/412 |
| 5,974,309 | 10/1999 | Foti | 455/412 |
| 5,995,824 | 11/1999 | Whitfield et al. | 455/412 |
| 6,009,321 | 12/1999 | Wang et al. | 455/410 |
| 6,021,325 | 2/2000 | Hall | 455/412 |
| 6,052,454 | 4/2000 | Kek et al. | 379/188 |
| 6,052,438 | 4/2000 | Wu et al. | 379/067.1 |
| 6,058,163 | 5/2000 | Pattison et al. | 379/034 |
| 6,078,648 | 6/2000 | Albers et al. | 379/035 |
| 6,072,860 | 6/2000 | Kek et al. | 379/088.25 |
| 6,104,799 | 8/2000 | Jain et al. | 379/210 |
| 6,097,798 | 8/2000 | Albers et al. | 379/114 |
| 6,122,357 | 9/2000 | Farris et al. | 379/207 |

### SUMMARY OF THE INVENTION

The present invention seeks to provide an improved and enhanced recording system and methodology. There is thus provided in accordance with a preferred embodiment of the present invention, in a mobile communications environment including a multiplicity of mobile communicators in communication with a plurality of communications centers, a communications recording system including:

a plurality of communications recorders located at disparate physical locations and providing a multiplicity of recorded communications;

a plurality of recorded communication storage facilities located at the disparate physical locations, each storage facility at a given one of the disparate physical locations being capable of storing plural recorded communications recorded by a communications recorder at the location; and

at least one recorded communication retriever operative to locate and retrieve selected ones of the plurality of stored communications from at least one of the plurality of recorded communication storage facilities in accordance with selection criteria.

There is also provided in accordance with a preferred embodiment of the present invention, in an IP communications environment including a multiplicity of communicators in IP communication with a plurality of communications centers, a communications recording system including a plurality of communication recorders operative to record communications involving ones of the multiplicity of IP communicators.

There is additionally provided in accordance with a preferred embodiment of the present invention, in a communications environment including a multiplicity of communicators in communication with a plurality of communications centers organized into a plurality of networks, a communications recording system including:

at least one communication recorder operative to record communications involving ones of the multiplicity of communicators, the plurality of communication recorders are operative to record communications involving plural ones of the plurality of networks.

There is further provided in accordance with a preferred embodiment of the present invention, in a communications environment including a multiplicity of communicators in communication with a plurality of communications centers including at least one PBX, a communications recording system including:

at least one communication recorder operative to record communications involving ones of the multiplicity of communicators, the ones of the communicators including communicators connected to the at least one PBX.

There is still further provided in accordance with a preferred embodiment of the present invention, in a communications environment including a multiplicity of communicators in communication with a plurality of communications centers, a communications recording system including:

at least one communication recorder operative to record communications involving ones of the multiplicity of communicators; and

a recording notifier operative to provide notification of recording to at least one party to the communications.

Additionally in accordance with a preferred embodiment of the present invention there is provided in a communications environment including a multiplicity of communicators in communication with a plurality of communications centers, a communications recording system including:

at least one network-based communication recorder operative to record communications involving ones of the multiplicity of communicators; and

at least one communicator-based communication recorder operative to record communications involving at least one of the multiplicity of communicators in response to a first input provided by a user of the communicator.

Further in accordance with a preferred embodiment of the present invention there is provided in a communications environment including a multiplicity of communicators in communication with a plurality of communications centers, a communications recording system including:

at least one network-based communication recording facility operative to record communications involving ones of the multiplicity of communicators;

at least one communicator-based communication recorder operative to record communications involving at least one of the multiplicity of communicators; and

a recording transferor operative to transfer recorded communications from the at least one communicator-based communication recorder to the at least one network-based communication recording facility.

Also in accordance with a preferred embodiment of the present invention there is provided, in a mobile communications environment including a multiplicity of mobile communicators in communication with a plurality of communications centers, a communications recording method including:

employing a plurality of communications recorders located at disparate physical locations to provide a multiplicity of recorded communications;

providing a plurality of recorded communication storage facilities at the disparate physical locations, each storage facility at a given one of the disparate physical locations being capable of storing plural recorded communications recorded by a communications recorder at the location; and

locating and retrieving selected ones of the plurality of stored communications from at least one of the plurality of recorded communication storage facilities in accordance with selection criteria.

There is additionally provided in accordance with a preferred embodiment of the present invention, in an IP communications environment including a multiplicity of communicators in IP communication with a plurality of communications centers, a communications recording method including utilizing a plurality of communication recorders to record communications involving ones of the multiplicity of IP communicators.

There is additionally provided in accordance with a preferred embodiment of the present invention in a communications environment including a multiplicity of communicators in communication with a plurality of communications centers organized into a plurality of networks, a communications recording method including:

recording communications involving ones of the multiplicity of communicators and plural ones of the plurality of networks.

There is additionally provided in accordance with a preferred embodiment of the present invention, in a communications environment including a multiplicity of communicators in communication with a plurality of communications centers including at least one PBX, a communications recording method including:

recording communications involving ones of the multiplicity of communicators, the ones of the communicators including communicators connected to the at least one PBX.

There is further provided in accordance with a preferred embodiment of the present invention, in a communications environment including a multiplicity of communicators in communication with a plurality of communications centers, a communications recording method including:

recording communications involving ones of the multiplicity of communicators; and

providing notification of recording to at least one party to the communications.

There is still further provided in accordance with a preferred embodiment of the present invention, in a communications environment including a multiplicity of communicators in communication with a plurality of communications centers, a communications recording method including:

providing network based recording of communications involving ones of the multiplicity of communicators and

providing communicator-based communication recording of communications involving at least one of the multiplicity of communicators in response to a first input provided by a user of a communicator.

In accordance with a still further embodiment of the present invention, there is provided, in a communications environment including a multiplicity of communicators in communication with a plurality of communications centers, a communications recording method including:

providing network-based communication recording of communications involving ones of the multiplicity of communicators;

providing communicator-based communication recording of communications involving at least one of the multiplicity of communicators; and

transferring recorded communications from the at least one communicator-based communication recording to the network-based communication recording.

Preferably, the method includes providing notification of recording to at least one party to the communications.

In accordance with a preferred embodiment of the present invention, the method includes providing notification of recording to parties to the communications, which fulfill predetermined selected criteria.

Additionally in accordance with a preferred embodiment of the present invention, the method includes identifying a user irrespective of which network the user employs to initiate the communications.

Preferably, the at least one recorded communication retriever is also operative to supply the selected ones of the plurality of stored recorded communications to corresponding users in accordance with supply criteria.

In accordance with a preferred embodiment of the present invention, at least one participant in at least one of the recorded communications is at least one of the corresponding users.

Preferably, the selection criteria and the supply criteria for at least one of the stored recorded communication are determined by at least one of the corresponding users.

In accordance with a preferred embodiment of the present invention, the communications remain stored in the recorded communication storage facilities until retrieved or until following a predetermined extended period of time.

Preferably, the selection criteria and the supply criteria are pre-selected.

In accordance with a preferred embodiment of the present invention, the recordings of the communications are located at locations in propinquity to the location of corresponding ones of the multiplicity of communications centers.

Preferably, the mobile communications environment includes at least one voice over IP link.

In accordance with a preferred embodiment of the present invention, the mobile communications environment includes a plurality of networks, at least one of which is a mobile communications network, which networks are interconnected and the communication recorders are operative to record communications involving plural ones of the plurality of networks.

Preferably, the recording system also includes a recording notifier operative to provide notification of recording to at least one party to the communications.

In accordance with a preferred embodiment of the present invention, the recording notifier is operative to provide notification of recording to parties to the communications which parties fulfill predetermined selected criteria.

Preferably, the predetermined selected criteria are user configurable via the multiplicity of mobile communicators.

In accordance with a preferred embodiment of the present invention, the predetermined selected criteria are user configurable during the communications.

The plurality of networks may include at least one mobile communications network, a landline network and a voice over IP network.

The system preferably also includes a cross-network user identifier operative to identify a user irrespective of which network the user employs to initiate the communications.

In accordance with a preferred embodiment of the present invention the at least one network is connected to a PBX and the at least one communication recorder is operative to record communications involving the PBX.

Preferably, the system also includes a PBX extension identifier operative to identify at least one PBX extension.

In accordance with a preferred embodiment of the present invention wherein the PBX includes a communications recording facility, the communication recording system also including an interface enabling communication between the communications recording facility and the at least one communication recorder.

### BRIEF DESCRIPTION OF THE DRAWINGS

The present invention will be understood and appreciated more fully from the following detailed description, taken in conjunction with the drawings in which:

FIG. 1 is a simplified partially pictorial functional block diagram illustrating a preferred embodiment of the present invention, including a multiplicity of mobile communicators in communication with a plurality of communications centers and a plurality of communications recorders located at disparate physical locations;

FIGS. 2A, 2B, 2C, 2D, 2E & 2F are simplified functional block diagrams, illustrating various implementations of the functionality of FIG. 1;

FIGS. 3A, 3B, 3C, 3D, 3E & 3F are simplified flow charts illustrating operation of the functionality shown in respective FIGS. 2A, 2B, 2C, 2D, 2E & 2F;

FIG. 4 is a simplified partially pictorial functional block diagram illustrating a preferred embodiment of the present invention, including a multiplicity of communicators in IP communication with a plurality of communications centers and a plurality of communications recorders operative to record communications involving ones of said multiplicity of IP communicators;

FIG. 5A is a simplified functional block diagram, illustrating various implementation aspects of the functionality of FIG. 4;

FIG. 6A is a simplified flow chart illustrating operation of the functionality shown in respective FIG. 5A;

FIG. 7 is a simplified partially pictorial functional block diagram illustrating a preferred embodiment of the present invention, including a multiplicity of communicators in communication with a plurality of communications centers organized into a plurality of networks and a plurality of communications recorders operative to record communications involving ones of said multiplicity of communicators, regardless of the network they are served by;

FIGS. 8A, 8B & 8C are simplified functional block diagrams, illustrating various implementations of the functionality of FIG. 7;

FIGS. 9A, 9B & 9C are simplified flow charts illustrating operation of the functionality shown in respective FIGS. 8A, 8B & 8C;

FIG. 10 is a simplified partially pictorial functional block diagram illustrating a preferred embodiment of the present invention including, a multiplicity of communicators in communication with a plurality of communications centers, with at least one of the communicators communicates through a PBX, and a plurality of communication recorders.

FIGS. 11A & 11B are simplified functional block diagrams, illustrating various implementations of the functionality of FIG. 10;

FIGS. 12A & 12B are simplified flow charts illustrating operation of the functionality shown in respective FIGS. 11A & 11B;

FIG. 13 is a simplified partially pictorial functional block diagram illustrating a preferred embodiment of the present invention, including a multiplicity of communicators in communication with a plurality of communications centers and at least one network-based and one communicator-based communications recorders operative to record communications involving ones of said multiplicity of communicators.

FIG. 14A is a simplified functional block diagram, illustrating various implementations of the functionality of FIG. 13; and

FIG. 15A is a simplified flow chart illustrating operation of the functionality shown in respective FIG. 14A;

### DETAILED DESCRIPTION OF PREFERRED EMBODIMENTS

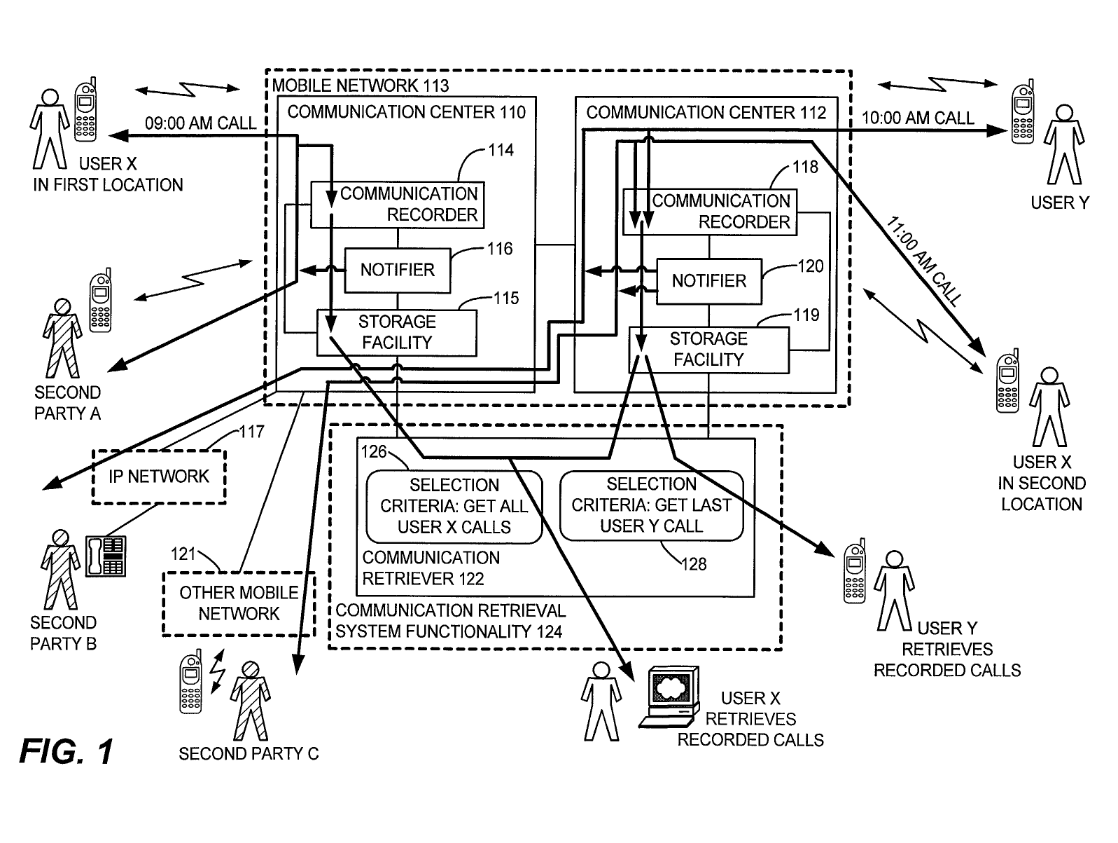

Reference is now made to FIG. 1, which is a simplified partially pictorial functional block diagram illustrating a preferred embodiment of the present invention, including a multiplicity of mobile communicators in communication with a plurality of communications centers and a plurality of communications recorders located at disparate physical locations.

The illustrated embodiment of FIG. 1 is presented in the context of cellular telephone communications, it is understood that this embodiment of the invention is not limited to cellular communications and is equally applicable to other suitable types of communications networks. In FIG. 1, first and second communications centers 110 and 112 are shown and typically correspond to mobile switching centers in a mobile network 113, such as a cellular network. In accordance with a preferred embodiment of the present invention, each communication center includes, in addition to equipment normally found in a mobile switching center, a communication recorder, which outputs to a storage facility, and a notifier operative to indicate the call parties of the recording taking place.

For the purposes of illustration of the present invention, FIG. 1 shows recording of a 9:00 AM call, between a user X and a second party A, which is handled entirely by first communication center 110. This call is recorded by a communication recorder 114 and the recording is stored in a storage facility 115, both resident at communication center 110. During the call, a notifier 116 may provide recording notifications to some or all the parties of the call.

A 10:00 AM call, between a user Y located in the service area of communication center 112 and a second party B, located in the service area of an internet protocol (IP) network, designated by reference numeral 117, is recorded by a communication recorder 118 and the recording is stored in a storage facility 119, both resident at communication center 112, which is the communication center in whose service area the user Y is located. During the call, a notifier 120 may provide recording notifications to some or all the parties of the call.

An 11:00 AM call, between the user X, currently located in the service area of communication center 112 and a second party C, located in the service area of another mobile network, designated by reference numeral 121, is recorded by communication recorder 118 and the recording is stored in storage facility 119, both resident at communication center 112, which is the communication center in whose service area the user X is located at the time of the call. During the call, notifier 119 may provide recording notifications to some or all the parties of the call.

When the users X and Y wish to retrieve recordings of the calls that they requested be recorded, they typically activate communication retriever 122, which, by applying selection criteria established by the respective users, obtains the recordings from the various distributed storage facilities. Thus it is seen that according to user X's selection criteria 126, his calls are retrieved from the storage facilities 115 and 119, at the respective communication centers serving the service areas within which user X was located at the time of the calls. Similarly, user Y's call is retrieved according to selection criteria 128 from the storage facility 119.

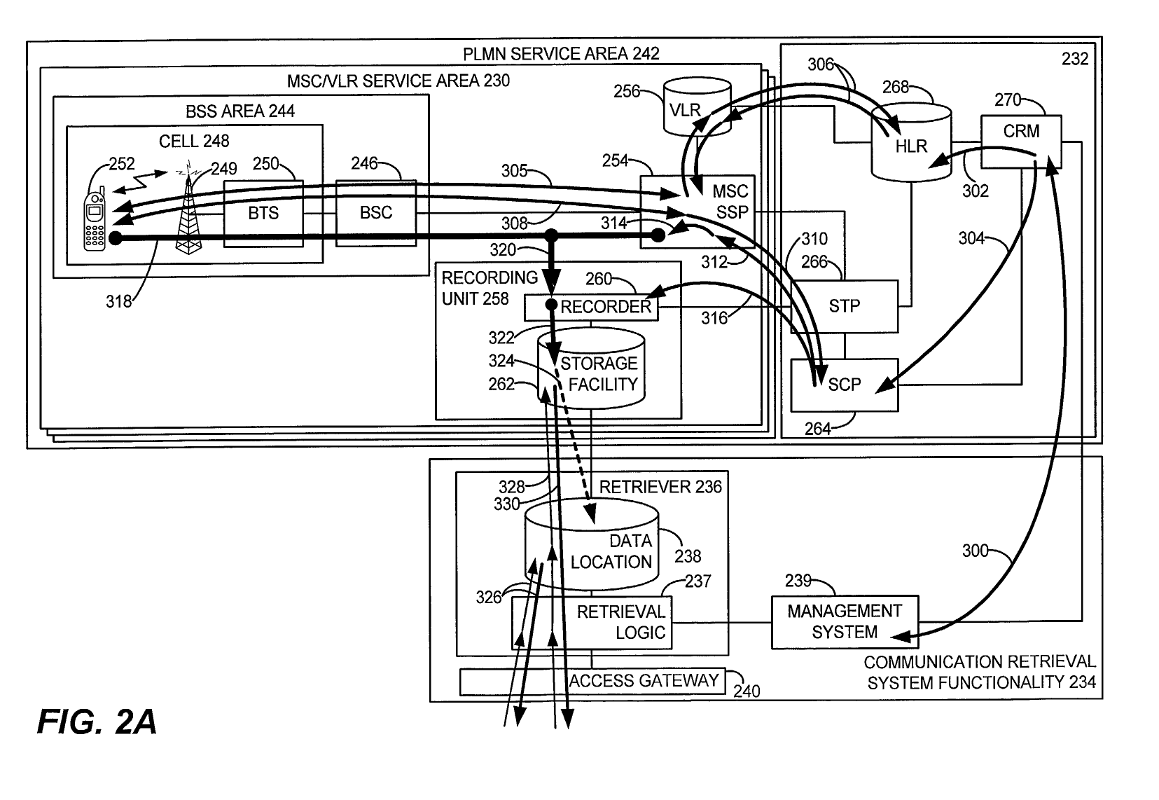

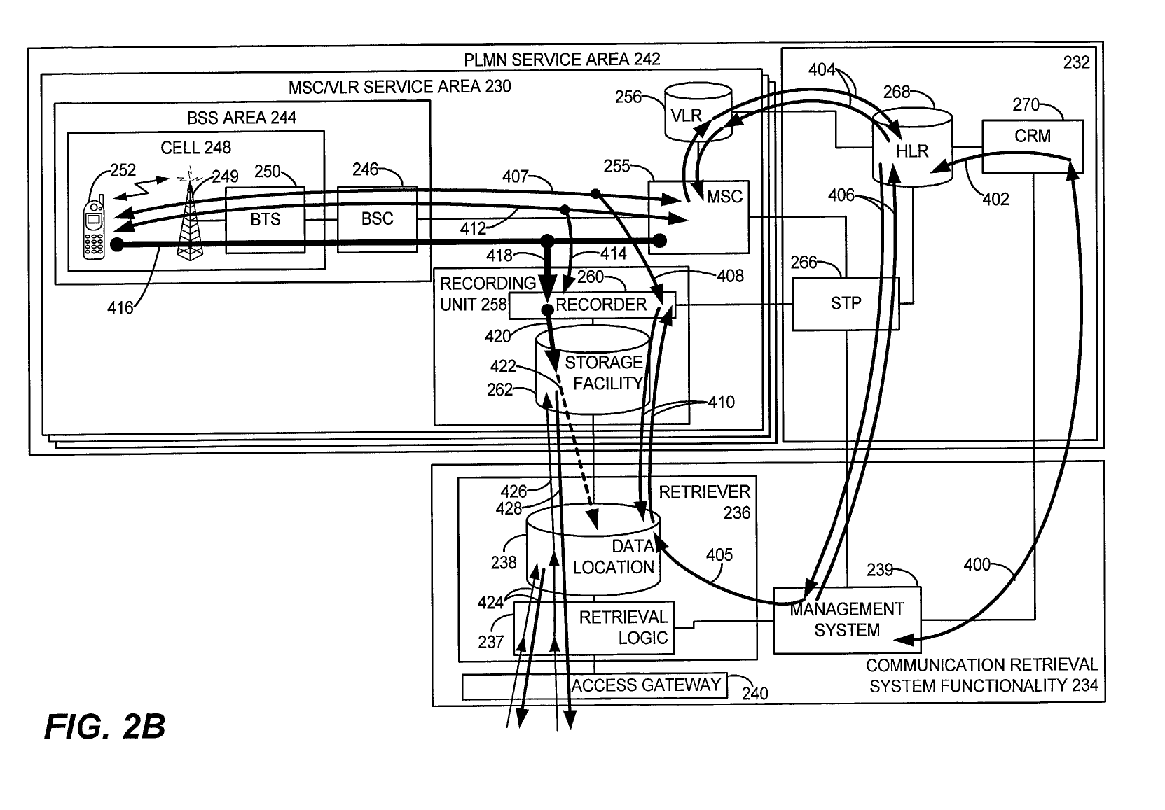

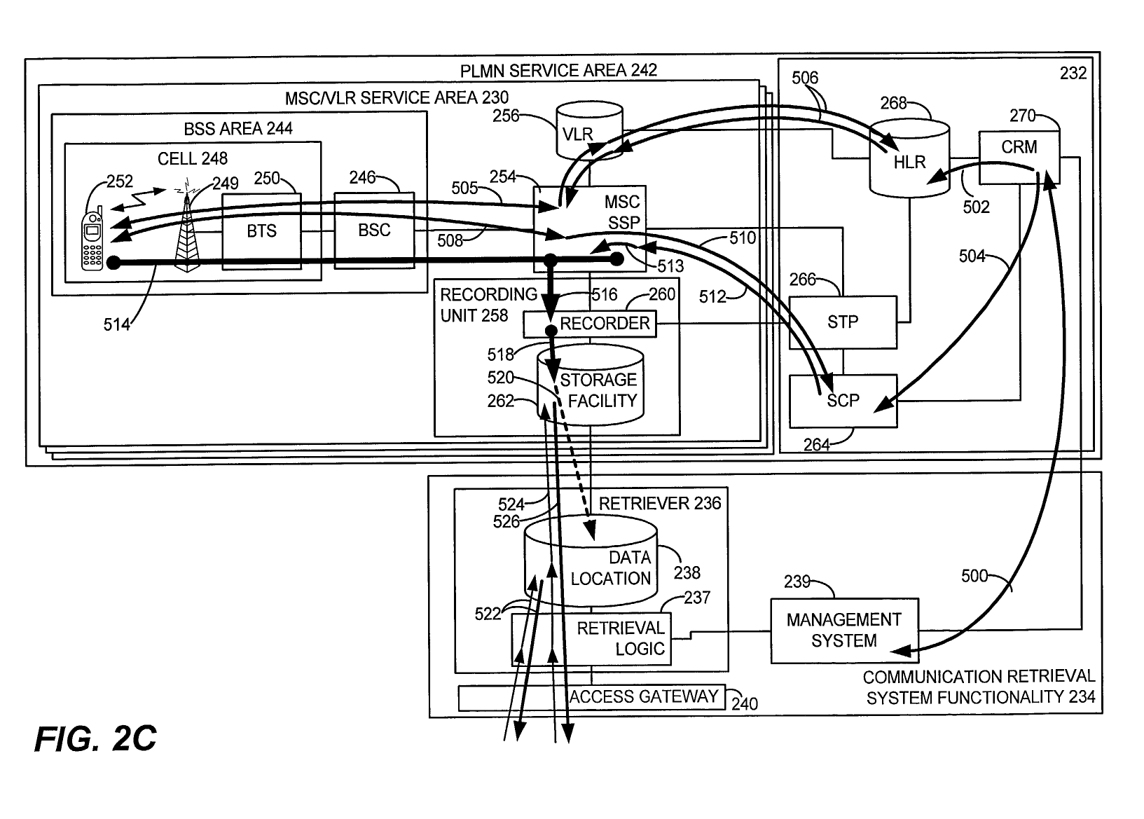

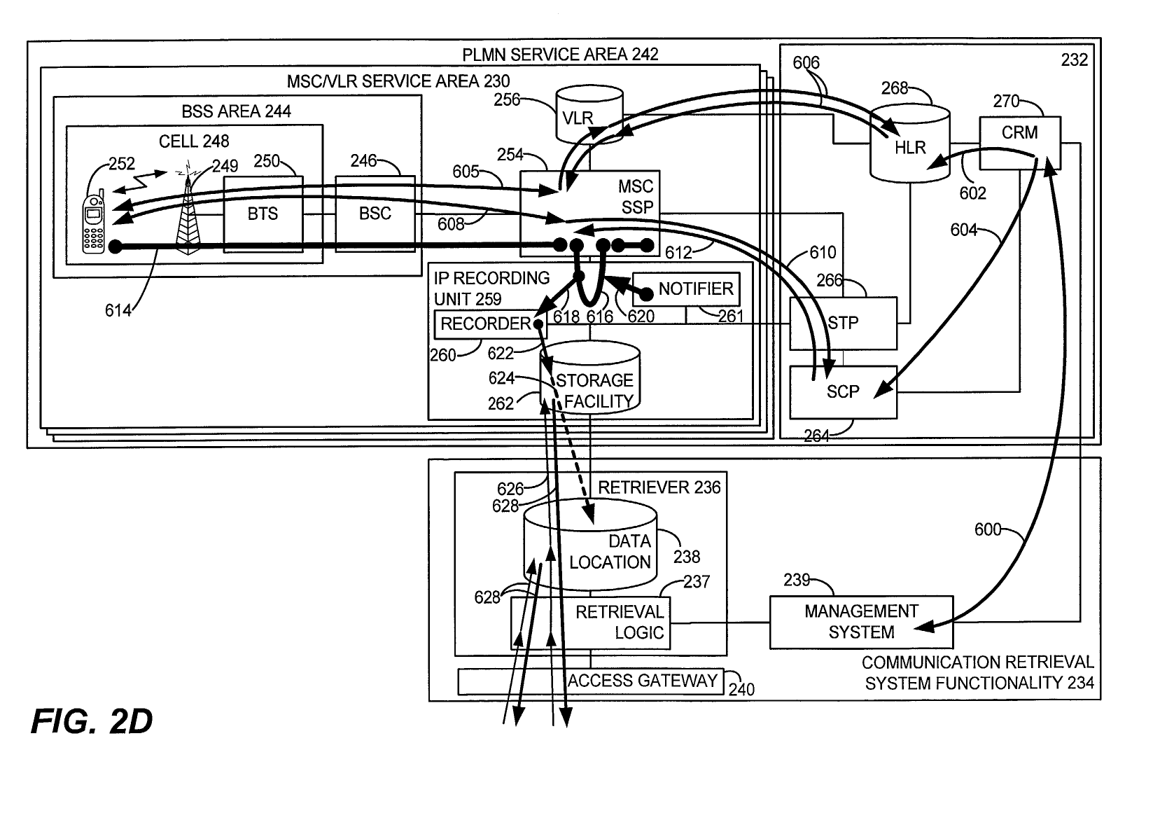

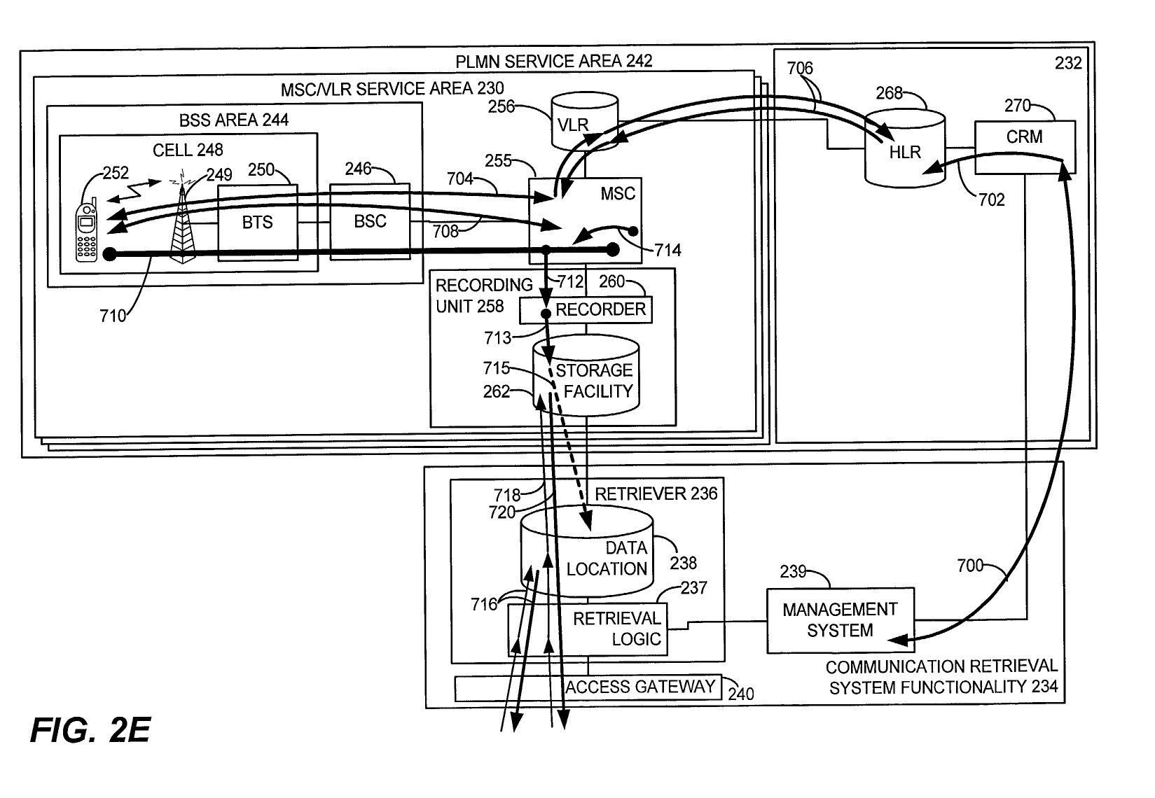

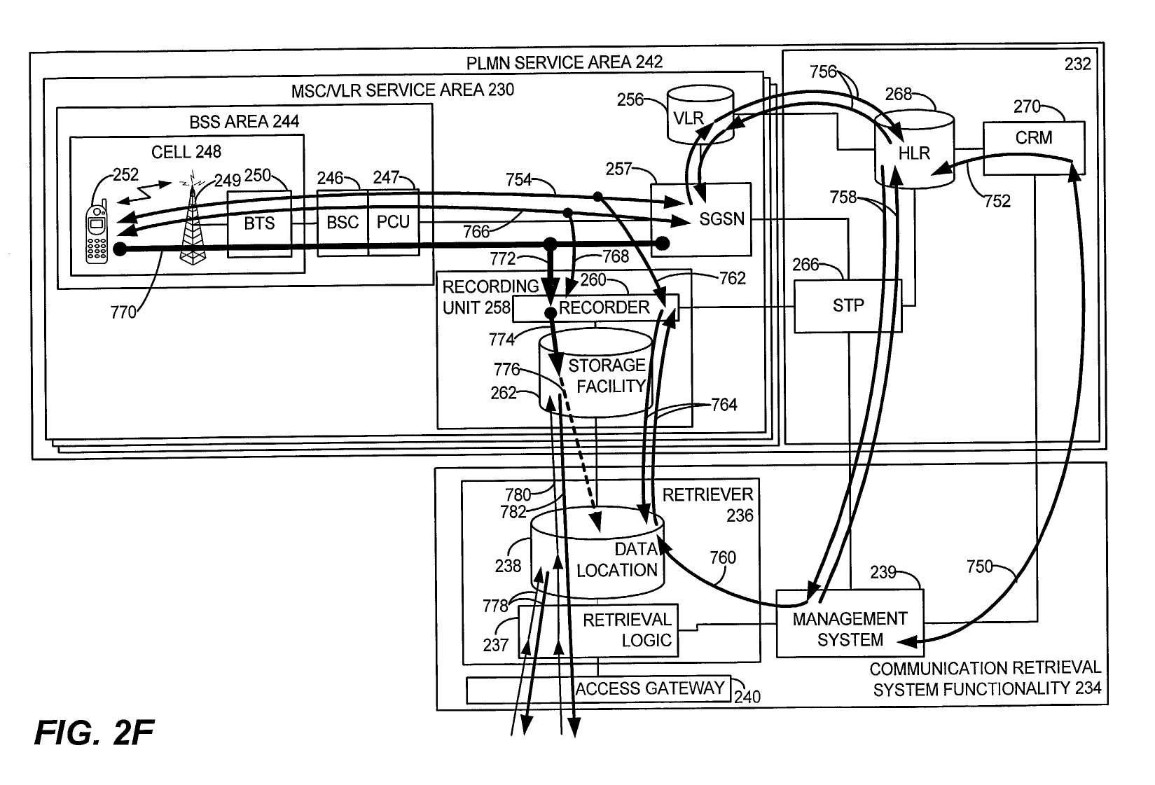

Reference is now made to FIGS. 2A, 2B, 2C, 2D, 2E & 2F which are simplified functional block diagrams illustrating various implementations of the functionality of FIG. 1. All the figures shows the general structure of one communication center here designated 230, such as communication center 110 (FIG. 1), additional mobile network functionality, designated generally by reference numeral 232 which serves multiple communication centers 230. As well as communication retrieval system functionality, designated by reference numeral 234, which includes one or more communication retrievers 236 such as communication retriever functionality 122 (FIG. 1), and which preferably include retrieval logic 237 and a data location database 238 as well as a management subsystem 239 and an access gateway 240.

Turning to FIG. 2A, it is seen that a public land mobile network (PLMN) service area, designated by reference numeral 242, which corresponds to the service area of mobile network 113 (FIG. 1) typically includes a plurality of communication centers 230 served by functionality 232. The service area served by each of communication centers 230 is termed a Mobile Switching Center/Visitor Location Register (MSC/VLR) service area.

Within the MSC/VLR service area there are defined a plurality of Base Station Subsystem (BSS) areas, each designated by reference numeral 244 and typically including a Base Station Controller (BSC) 246, which services multiple cells 248. Each cell typically includes an antenna 249, which is associated with a Base Transceiver Station (BTS) 250 and which services a multiplicity of mobile communicators 252 when they are located within the service area of each cell.

Also located within the MSC/VLR service area is a Mobile Switching Center (MSC) 254, which also serves as a Service Switching Point (SSP) and is coupled to a Visitor Location Register (VLR) database 256. In accordance with a preferred embodiment of the present invention, a recording unit 258 is associated with each MSC 254 and typically includes a communication recorder 260, such as recorder 114 (FIG. 1), typically operative to receive a copy of MSC 254 communications, record it and store it in a storage facility 262, such as storage facility 116 (FIG. 1).

A Service Control Point (SCP) 264 provides control inputs via a Signal Transfer Point (STP) 266 to multiple MSCs 254. A Home Location Register (HLR) 268 serves as a network wide location database and provides outputs to VLR 256. HLR 268 and SCP 264 receive user details and settings from a Customer Relation Management (CRM) subsystem 270.

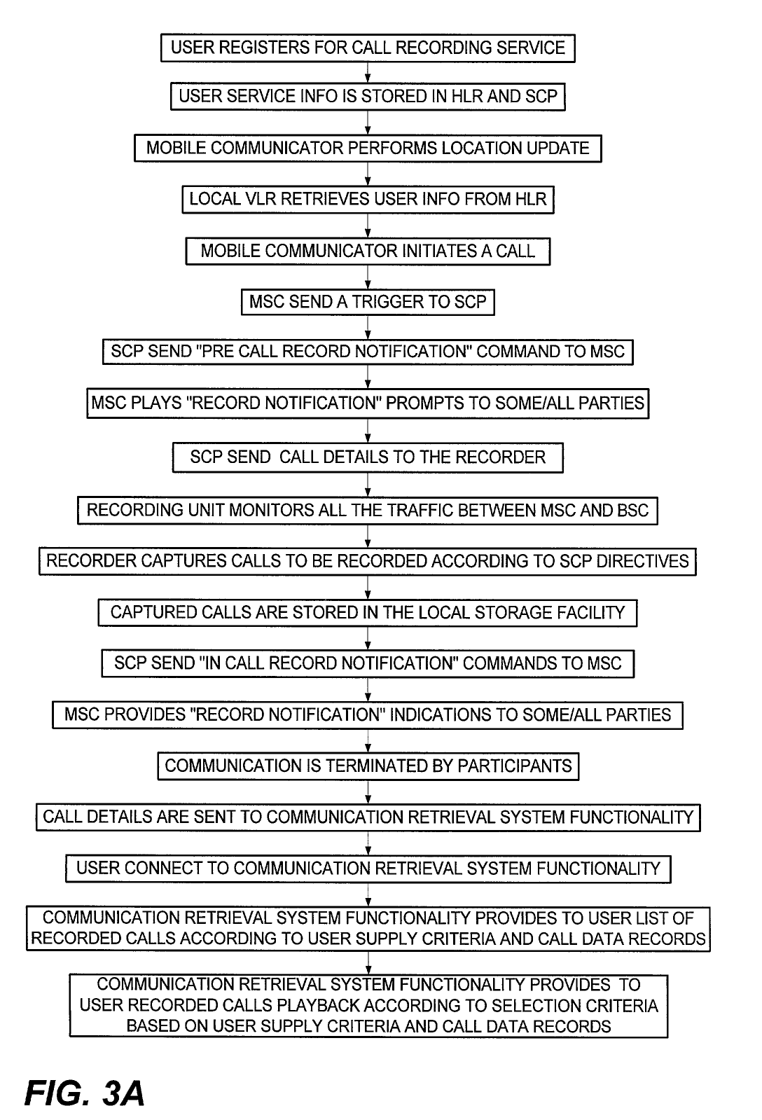

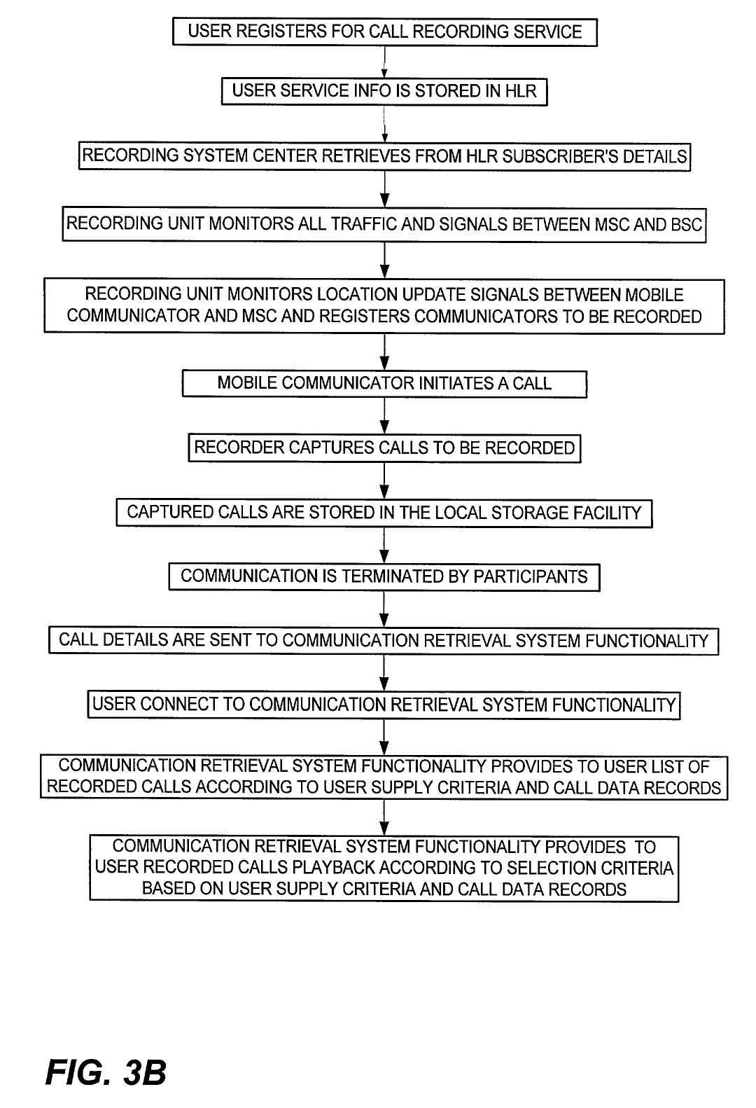

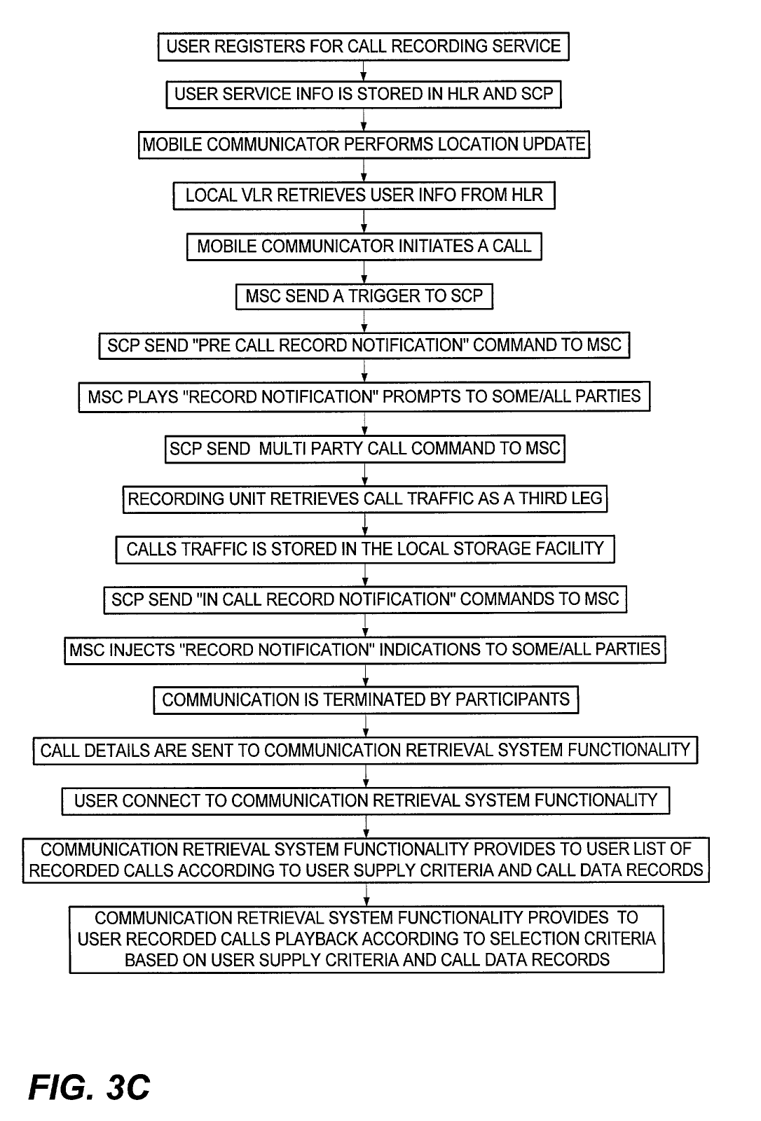

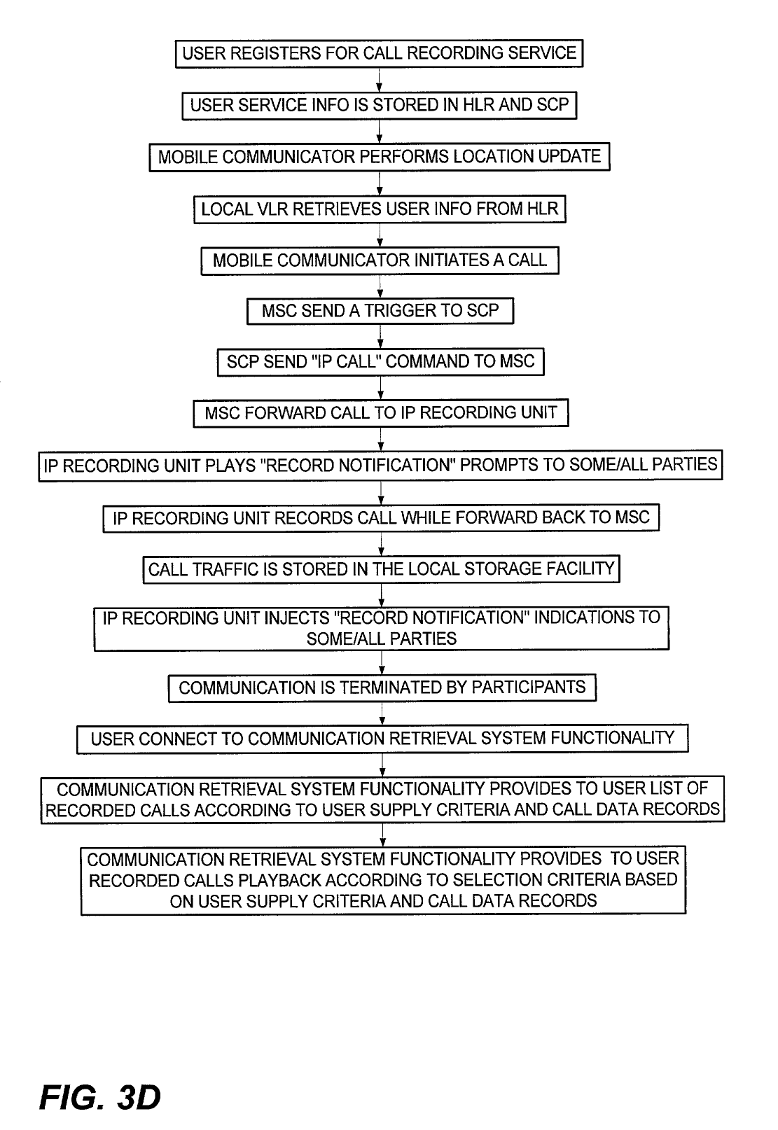

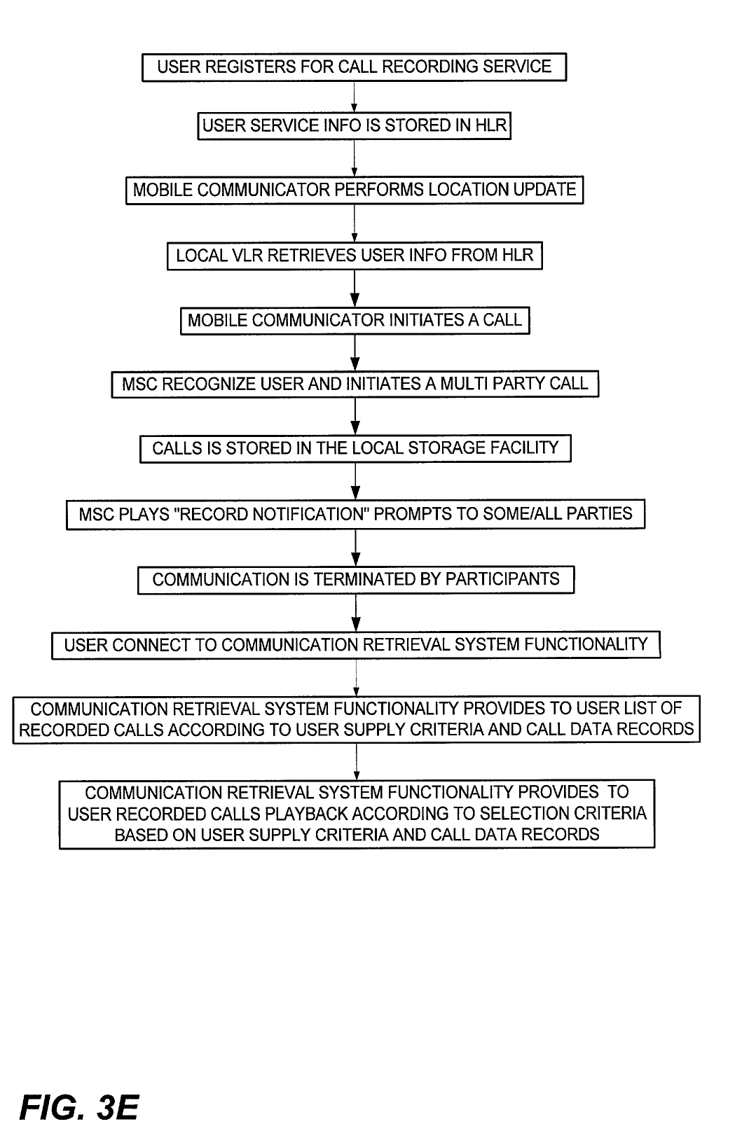

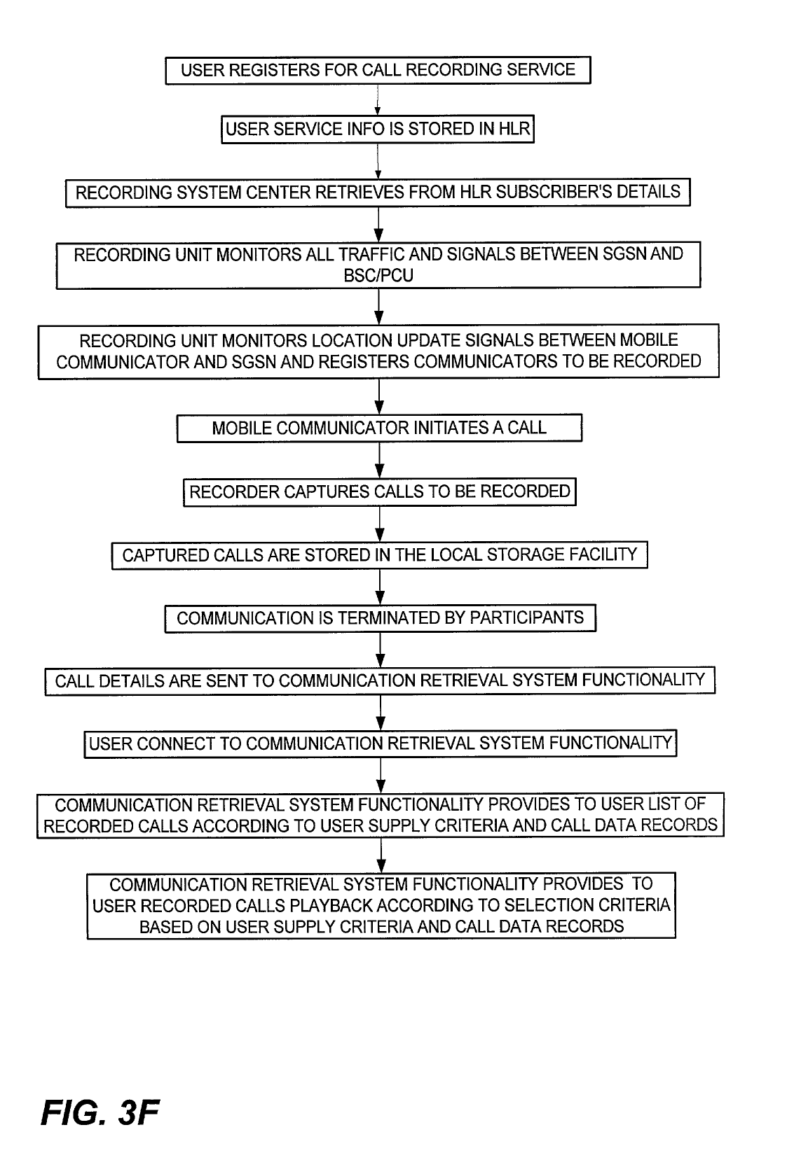

The functionality of the embodiment of FIG. 2A may be better understood from the following brief functional description which also relates to the flowchart of FIG. 3A:

Each user, being a person who wishes to have some or all of his calls recorded, may be registered by a suitable communication, designated by reference numeral 300 in FIG. 2A, between management subsystem 239 and CRM subsystem 270. Upon registration, the CRM subsystem 270 updates HLR 268 by a suitable communication, designated by reference numeral 302 in FIG. 2A and the SCP 264 by a suitable communication, designated by reference numeral 304 in FIG. 2A.

Upon receipt of location update signals by MSC 254 from mobile communicator 252 by suitable communication, designated by reference numeral 305 in FIG. 2A, the HLR 268 updates VLR 256 of the MSC 254 handling the call for the registered user, by suitable interactive communications, collectively designated by reference numeral 306 in FIG. 2A.

As part of a call initialization, call signaling takes place between the mobile communicator 252 and the MSC 254 by a suitable communication, designated by reference numeral 308 in FIG. 2A. The MSC 254 sends a suitable trigger to SCP 264 by a suitable communication, designated by reference numeral 310 in FIG. 2A. The SCP 264 then may send a “PRE CALL RECORD NOTIFICATION” command to the MSC 254 by a suitable communication, designated by reference numeral 312 in FIG. 2A. In response to this command, the MSC 254 may play “RECORD NOTIFICATION” prompts to some or all of the parties to the call by a suitable communication, designated by reference numeral 314 in FIG. 2A.

The SCP 264 sends details of the call to recorder 260 by a suitable communication, designated by reference numeral 316 in FIG. 2A which typically monitors some or all of the traffic between the MSC 254 and the mobile communicator 252 by a suitable communication, designated by reference numeral 318 in FIG. 2A. The term “traffic” is here employed to denote all of the communications in a call with the exception of the signaling. The recorder 260 is preferably operative to capture all of the traffic of every call that it is instructed to record by a suitable communication, designated by reference numeral 320 in FIG. 2A and to store this recorded traffic in storage facility 262 by a suitable communication, designated by reference numeral 322 in FIG. 2A.

The SCP 264 may send “IN CALL RECORD NOTIFICATION” commands to the MSC 254 by a suitable communication, designated by reference numeral 312 in FIG. 2A. The MSC 254 may then provide “RECORD NOTIFICATION” indications to some or all parties to the call by a suitable communication, designated by reference numeral 314 in FIG. 2A.

Upon termination of the call, and alternatively or additionally at the beginning of or during the call, the call details are supplied to communication retrieval system functionality 234 by a suitable communication, designated by reference numeral 324 in FIG. 2A.

A listing, index or any other suitable indication of the calls recorded at the behest of a user may be provided to the user in any suitable format at any suitable time based on the information stored by the communication retrieval system functionality 234. Such listing may be provided based on suitable interactive communications, collectively designated by reference numeral 326 in FIG. 2A.

When the user wishes to receive a playback of a call through his mobile communicator 252 or through another terminal, he typically designates the call in data location 238 through access gateway 240 and retrieval logic 237 by suitable communications, collectively designated by reference numeral 328 in FIG. 2A. The traffic of that call is supplied to the user at the user mobile communicator 252 or other terminal from the storage facility 262 by a suitable communication, designated by reference numeral 330 in FIG. 2A.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

Reference is now made to FIG. 2B, which differs from that of FIG. 2A in that whereas FIG. 2A shows a combined Intelligent Network (IN) and traffic monitoring implementation of the present invention, FIG. 2B shows a traffic monitoring implementation of the present invention.

The embodiment of FIG. 2B is identical to that of FIG. 2A other than in the following respects:

SCP 264 in the embodiment of FIG. 2A is not present in the embodiment of FIG. 2B.

MSC 254 in the embodiment of FIG. 2A, which includes SSP functionality is replaced in the embodiment of FIG. 2B by MSC 255, which lacks this functionality.

The functionality of the embodiment of FIG. 2B may be better understood from the following brief functional description which also relates to the flowchart of FIG. 3B:

Each user, being a person who wishes to have some or all of his calls recorded, may be registered by a suitable communication, designated by reference numeral 400 in FIG. 2B, between management subsystem 239 and CRM subsystem 270. Upon registration, the CRM subsystem 270 updates HLR 268 by a suitable communication, designated by reference numeral 402 in FIG. 2B.

Upon receipt of location update signals by MSC 255 from mobile communicator 252 by suitable communication, designated by reference numeral 407 in FIG. 2B, the HLR 268 updates VLR 256 of the MSC 255 handling a call for the registered user by suitable interactive communications, collectively designated by reference numeral 404 in FIG. 2B. As necessary, the HLR 268 also updates the management subsystem 239 by suitable interactive communications, collectively designated by reference numeral 406 in FIG. 2B. Consequently, the management subsystem 239 updates data location 238 by suitable communication, designated by reference numeral 405 in FIG. 2B.

Recording unit 258 typically monitors the signaling between the mobile communicators 252 and the MSC 255, designated by reference numeral 407 in FIG. 2B, by a suitable communication, designated by reference numeral 408 in FIG. 2B. Upon receipt of location update signals by the MSC 255 from the mobile communicator 252, the recording unit 258 retrieves user identification information regarding the given mobile communicator 252 from the data location 238 by a suitable interactive communications, collectively designated by reference numeral 410 in FIG. 2B.

As part of a call initialization, call signaling takes place between the mobile communicator 252 and the MSC 255 by a suitable communication, designated by reference numeral 412 in FIG. 2B. The recorder 260 typically identifies calls to be recorded by monitoring the call signaling between the MSC 255 and the mobile communicator 252 by a suitable communication, designated by reference numeral 414 in FIG. 2B.

During a call, call traffic takes place between the mobile communicator 252 and the MSC 255 by a suitable communication, designated by reference numeral 416 in FIG. 2B. The recorder 260 preferably monitors all of the traffic between the MSC 255 and the mobile communicators 252 by a suitable communication, designated by reference numeral 418 in FIG. 2B and is typically operative to capture and to store some or all of the traffic of some or every call that was identified as to be recorded in storage facility 262 by a suitable communication, designated by reference numeral 420 in FIG. 2B.

Upon termination of the call, and alternatively or additionally at the beginning of or during the call, the call details are supplied to communication retrieval system functionality 234 by a suitable communication, designated by reference numeral 422 in FIG. 2B.

A listing, index or any other suitable indication of the calls recorded at the behest of a user may be provided to the user in any suitable format at any suitable time based on the information stored by the communication retrieval system functionality 234. Such listing may be provided based on suitable interactive communications, collectively designated by reference numeral 424 in FIG. 2B.

When the user wishes to receive a playback of a call through his mobile communicator 252 or through another terminal, he designates the call in data location 238 through access gateway 240 and retrieval logic 237 by suitable communications, collectively designated by reference numeral 426 in FIG. 2B. The traffic of that call is supplied to the user at the user mobile communicator 252 or other terminal from the storage facility 262 by a suitable communication, designated by reference numeral 428 in FIG. 2B.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

Reference is now made to FIG. 2C which differs from that of FIG. 2A in that whereas FIG. 2A shows a combined IN and traffic monitoring implementation of the present invention, FIG. 2C shows a pure IN implementation of the present invention.

The structure shown in FIG. 2C is identical of that of FIG. 2A, however the functionality thereof is different.

The functionality of the embodiment of FIG. 2C may be better understood from the following brief functional description which also relates to the flowchart of FIG. 3C:

Each user, being a person who wishes to have some or all of his calls recorded, may be registered by a suitable communication, designated by reference numeral 500 in FIG. 2C, between management subsystem 239 and CRM subsystem 270. Upon registration, the CRM subsystem 270 updates HLR 268 by a suitable communication, designated by reference numeral 502 in FIG. 2C and the SCP 264 by a suitable communication, designated by reference numeral 504 in FIG. 2C.

Upon receipt of location update signals by MSC 254 from mobile communicator 252 by suitable communication, designated by reference numeral 505 in FIG. 2C, the HLR 268 updates VLR 256 of the MSC 254 handling a call for the registered user by suitable interactive communications, collectively designated by reference numeral 506 in FIG. 2C.

As part of a call initialization, call signaling takes place between the mobile communicator 252 and the MSC 254 by a suitable communication, designated by reference numeral 508 in FIG. 2C. The MSC 254 sends a suitable trigger to the SCP 264 by a suitable communication, designated by reference numeral 510 in FIG. 2C. The SCP 264 then may send a “PRE CALL RECORD NOTIFICATION” command to the MSC 254 by a suitable communication, designated by reference numeral 512 in FIG. 2C. In response to this command, the MSC 254 may play “RECORD is NOTIFICATION” prompts to some or all of the parties to the call by a suitable communication, designated by reference numeral 513 in FIG. 2C.

Before or during a call, the SCP 264 may also send to the MSC 254 a MULTI PARTY command by suitable communication, designated by reference numeral 512 in FIG. 2C. In response, the MSC 254 is typically operative to transfer, preferably by multi party functionality, to recorder 260 all of the traffic of every call that it is instructed to, by a suitable communication, designated by reference numeral 516 in FIG. 2C. The recorder 260, in turn, is operative to store the recorded traffic in storage facility 262 by a suitable communication, designated by reference numeral 518 in FIG. 2C.

During the call, the SCP 264 may send “IN CALL RECORD NOTIFICATION” commands to MSC 254 by a suitable communication, designated by reference numeral 512 in FIG. 2C. The MSC 254 may then provide “RECORD NOTIFICATION” indications to some or all parties to the call by a suitable communication, designated by reference numeral 513 in FIG. 2C.

Upon termination of the call, and alternatively or additionally at the beginning of or during the call, the call details are supplied to communication retrieval system functionality 234 by a suitable communication, designated by reference numeral 520 in FIG. 2C.

A listing, index or any other suitable indication of the calls recorded at the behest of a user may be provided to the user in any suitable format at any suitable time based on the information stored by the communication retrieval system functionality 234. Such listing may be provided based on suitable interactive communications, collectively designated by reference numeral 522 in FIG. 2C.

When the user wishes to receive a playback of a call through his mobile communicator 252 or through another terminal he typically designates the call in data location 238 through access gateway 240 and retrieval logic 237 by suitable interactive communications, collectively designated by reference numeral 524 in FIG. 2C. The traffic of that call is supplied to the user at the user mobile communicator 252 or other terminal from the storage facility 262 by a suitable communication, designated by reference numeral 526 in FIG. 2C.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

Reference is now made to FIG. 2D, which differs from that of FIG. 2A in that whereas FIG. 2A shows a combined IN and traffic monitoring implementation of the present invention, FIG. 2D shows an IN using an Intelligent Peripheral (IP) implementation of the present invention.

The embodiment of FIG. 2D is identical to that of FIG. 2A other than in the following respect:

Recording Unit 258 in the embodiment of FIG. 2A, is replaced in the embodiment of FIG. 2D by an Intelligent Peripheral (IP) recording unit 259, which includes a notifier 261, in addition to recorder 260 and storage facility 262 which are the same as with recording unit 258 in the embodiment of FIG. 2A.

The functionality of the embodiment of FIG. 2D may be better understood from the following brief functional description which also relates to the flowchart of FIG. 3D:

Each user, being a person who wishes to have some or all of his calls recorded, may be registered by a suitable communication, designated by reference numeral 600 in FIG. 2D, between management subsystem 239 and CRM subsystem 270. Upon registration, the CRM subsystem 270 updates HLR 268 by a suitable communication, designated by reference numeral 602 in FIG. 2D and the SCP 264 by a suitable communication, designated by reference numeral 604 in FIG. 2D.

Upon receipt of location update signals by MSC 254 from mobile communicator 252 by suitable communication, designated by reference numeral 605 in FIG. 2D, the HLR 268 updates VLR 256 of the MSC 254 handling a call for the registered user by suitable communications, designated by reference numeral 606 in FIG. 2D.

As part of a call initialization, call signaling takes place between the mobile communicator 252 and the MSC 254 by a suitable communication, designated by reference numeral 608 in FIG. 2D. The MSC 254 sends a suitable trigger to the SCP 264 by a suitable communication, designated by reference numeral 610 in FIG. 2D. The SCP 264 then sends a “Intelligent Peripheral (IP) CALL” command to the MSC 254 by a suitable communication, designated by reference numeral 612 in FIG. 2D. In response, the traffic between the communicator 252 and the MSC 254, designated by numeral 614 in FIG. 2D, is forwarded by the MSC 254 to IP recording unit 259 by a suitable communication, designated by reference numeral 616 in FIG. 2D. The IP recording unit 259 is typically operative to forward the traffic designated by numeral 616 in FIG. 2D back to the MSC 254 or to another MSC 254 in PLMN 242 whilst providing a copy of the traffic to recorder 260 by a suitable communication, designated by reference numeral 618 in FIG. 2D. The recorder 260 is typically operative to store the recorded traffic in storage facility 262 by a suitable communication, designated by reference numeral 622 in FIG. 2D.

During the call, notifier 261 may provide “RECORD NOTIFICATION” indications to some or all parties to the call by a suitable communication, designated by reference numeral 620 in FIG. 2D.

Upon termination of the call, and alternatively or additionally at the beginning of or during the call, the call details are supplied to communication retrieval system functionality 234 by a suitable communication, designated by reference numeral 622 in FIG. 2D.

A listing, index or any other suitable indication of the calls recorded at the behest of a user may be provided to the user in any suitable format at any suitable time based on the information stored by the communication retrieval system functionality 234. Such listing may be provided based on suitable interactive communications, collectively designated by reference numeral 624 in FIG. 2D.

When the user wishes to receive a playback of a call through his mobile communicator 252 or through another terminal he typically designates the call in data location 238 through access gateway 240 and retrieval logic 237 by suitable interactive communications, collectively designated by reference numeral 626 in FIG. 2D. The traffic of that call is supplied to the user at the user mobile communicator 252 or other terminal from the storage facility 262 by a suitable communication, designated by reference numeral 628 in FIG. 2D.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

Reference is now made to FIG. 2E, which differs from that of FIG. 2A in that whereas FIG. 2A shows a combined IN and traffic monitoring implementation of the present invention, FIG. 2E shows an internal switch implementation of the present invention.

The embodiment of FIG. 2E is identical to that of FIG. 2A other than in the following respects:

SCP 264 in the embodiment of FIG. 2A is not present in the embodiment of FIG. 2E.

STP 266 in the embodiment of FIG. 2A is not present in the embodiment of FIG. 2E.

MSC 254 in the embodiment of FIG. 2A, which includes SSP functionality is replaced in the embodiment of FIG. 2E by MSC 255, which lacks this functionality.

The functionality of the embodiment of FIG. 2E may be better understood from the following brief functional description which also relates to the flowchart of FIG. 3E:

Each user, being a person who wishes to have some or all of his calls recorded, may be registered by a suitable communication, designated by reference numeral 700 in FIG. 2E, between the management subsystem 239 and CRM subsystem 270. Upon registration, the CRM subsystem 270 updates HLR 268 by a suitable communication, designated by reference numeral 702 in FIG. 2E.

Upon receipt of location update signals by MSC 255 from mobile communicator 252 by suitable communication, designated by reference numeral 704 in FIG. 2E, the HLR 268 updates VLR 256 of each MSC 255 handling a call for the registered user by suitable communications, designated by reference numeral 706 in FIG. 2E.

As part of a call initialization, call signaling takes place between mobile communicator 252 and the MSC 255 by a suitable communication, designated by reference numeral 708 in FIG. 2E.

During a call, out of the total traffic between all mobile communicators 252 and MSC 255, designated by numeral 710 in FIG. 2E, the MSC 255 is preferably operative to provide to recording unit 258, by means of multi party functionality, some or all of the traffic of the call by a suitable communication, designated by reference numeral 712 in FIG. 2E. Recorder 260 is typically operative to store the recorded traffic in storage facility 262 by a suitable communication, designated by reference numeral 713 in FIG. 2E. The MSC 255 may provide “RECORD NOTIFICATION” indications to some or all parties to the call by a suitable communication, designated by reference numeral 714 in FIG. 2E.

Upon termination of the call, and alternatively or additionally at the beginning of or during the call, the call details are supplied to communication retrieval system functionality 234 by a suitable communication, designated by reference numeral 715 in FIG. 2E.

A listing, index or any other suitable indication of the calls recorded at the behest of a user may be provided to the user in any suitable format at any suitable time based on the information stored by the communication retrieval system functionality 234. Such listing may be provided based on suitable interactive communications, collectively designated by reference numeral 716 in FIG. 2E.

When the user wishes to receive a playback of a call through his mobile communicator 252 or through another terminal he typically designates the call in data location 238 through access gateway 240 and retrieval logic 237 by suitable interactive communications, collectively designated by reference numeral 718 in FIG. 2E. The traffic of that call is supplied to the user at a user mobile communicator 252 or other terminal from the storage facility 262 by a suitable communication, designated by reference numeral 720 in FIG. 2E.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user. Reference is now made to FIG. 2F, which differs from that of FIG. 2A in that whereas FIG. 2A shows a combined Intelligent Network (IN) and traffic monitoring implementation of the present invention, FIG. 2F shows a traffic monitoring of a packet data network, such as a Global Packet Radio Service (GPRS) network, implementation of the present invention. It is understood that this embodiment of the invention is not limited to GPRS communications and is equally applicable to Wideband Code Division Multiple Access (W-CDMA), Enhanced Data for Global Evolution (EDGE), Universal Mobile Telecommunications System (UMTS) and other suitable types of digital wireless communications.

The embodiment of FIG. 2F is identical to that of FIG. 2A other than in the following respects:

SCP 264 in the embodiment of FIG. 2A is not present in the embodiment of FIG. 2F.

MSC 254 in the embodiment of FIG. 2A is replaced in the embodiment of FIG. 2F by a Serving GPRS Support Node (SGSN) 257.

BSC 246 is added with a Packet Control Unit (PCU) 247, which typically provides packet data interface functionality.

The functionality of the embodiment of FIG. 2F may be better understood from the following brief functional description which also relates to the flowchart of FIG. 3F:

Each user, being a person who wishes to have some or all of his calls recorded, may be registered by a suitable communication, designated by reference numeral 750 in FIG. 2F, between management subsystem 239 and CRM subsystem 270. Upon registration, the CRM subsystem 270 updates HLR 268 by a suitable communication, designated by reference numeral 752 in FIG. 2F.

As part of an attach procedure between mobile communicator 252 and SGSN 257, here designated 754, the HLR 268 typically provides details of the mobile communicator 252 to VLR 256 which is associated with the SGSN 257 by suitable interactive communications, collectively designated by reference numeral 756 in FIG. 2F. As necessary, the HLR 268 also updates the management subsystem 239 by suitable interactive communications, collectively designated by reference numeral 758 in FIG. 2F. Consequently, the management subsystem 239 updates data location 238 by a suitable communication, designated by reference numeral 760 in FIG. 2F.

Recording unit 258 typically monitors the signaling 754 by a suitable communication, designated by reference numeral 762 in FIG. 2F. Upon interception of attach signals, the recording unit 258 typically retrieves user identification information regarding the given mobile communicator 252 from the data location 238 by suitable interactive communications, collectively designated by reference numeral 764 in FIG. 2F.

As part of a call initialization, call signaling takes place between the mobile communicator 252 and the SGSN 257 by a suitable communication, designated by reference numeral 766 in FIG. 2F. The recorder 260 typically identifies calls to be recorded by monitoring the signaling 766 by a suitable communication, designated by reference numeral 768 in FIG. 2F.

During a call, call traffic is sent between the mobile communicator 252 and the SGSN 257 by a suitable communication, designated by reference numeral 770 in FIG. 2F. The recorder 260 typically monitors all of the traffic between the SGSN 257 and the mobile communicators 252 by a suitable communication, designated by reference numeral 772 in FIG. 2F and is typically operative to capture and to store some or all of the traffic of some or every call that was identified as to be recorded in storage facility 262 by a suitable communication, designated by reference numeral 774 in FIG. 2F.

Upon termination of the call, and alternatively or additionally at the beginning of or during the call, the call details are supplied to communication retrieval system functionality 234 by a suitable communication, designated by reference numeral 776 in FIG. 2F.

A listing, index or any other suitable indication of the calls recorded at the behest of a user may be provided to the user in any suitable format at any suitable time based on the information stored by the communication retrieval system functionality 234. Such listing may be provided based on suitable interactive communications, collectively designated by reference numeral 778 in FIG. 2F.

When the user wishes to receive a playback of a call through his mobile communicator 252 or through another terminal, he typically designates the call in data location 238 through access gateway 240 and retrieval logic 237 by suitable communications, collectively designated by reference numeral 780 in FIG. 2F. The traffic of that call is preferably supplied to the user at the user mobile communicator 252 or other terminal from the storage facility 262 by a suitable communication, designated by reference numeral 782 in FIG. 2F.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

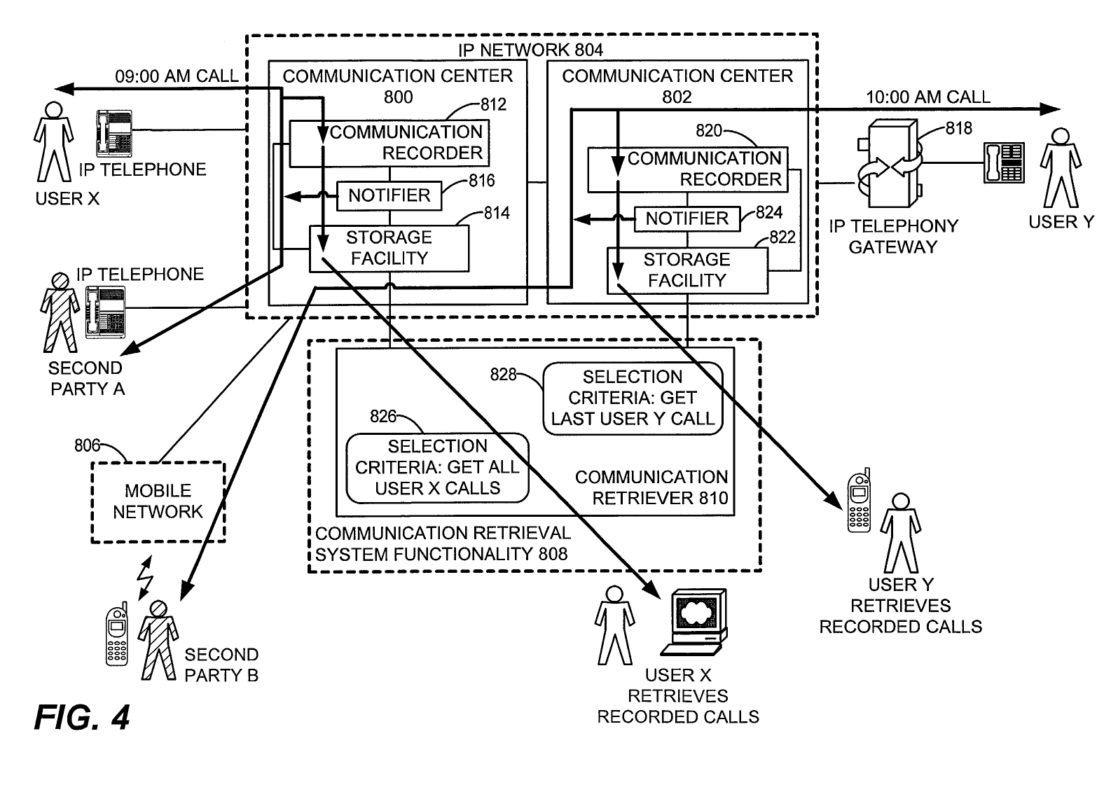

Reference is now made to FIG. 4, which is a simplified partially pictorial functional block diagram illustrating a preferred embodiment of the present invention, including a multiplicity of communicators in digital communication with a plurality of communications centers and a plurality of communications recorders operative to record communications involving ones of said multiplicity of IP communicators.

The illustrated embodiment of FIG. 4 is presented in the context of IP telephone communications, it is understood that this embodiment of the invention is not limited to IP communications and is equally applicable to other suitable types of digital communications. In FIG. 4, IP network 804 includes communications centers 800 and 802. In accordance with a preferred embodiment of the present invention, each communication center may include, in addition to equipment normally found in routing centers, a communication recorder, which outputs to a storage facility, and a notifier operative to indicate the call parties of the recording taking place. Also shown in FIG. 4, as being interconnected to IP network 804, is a mobile network 806.

In accordance with a preferred embodiment of the present invention, further shown in FIG. 4 is a communication retrieval system functionality 808, which includes a communication retriever 810.

For the purposes of illustration of the present invention, FIG. 4 shows recording of a 9:00 AM call, between a user X and a second party A, which is handled entirely by first communication center 800. This call is recorded by a communication recorder 812 and the recording is stored in a storage facility 814, both resident at communication center 800. During the call, a notifier 816 may provide recording notifications to some or all the parties of the call.

A 10:00 AM call, between a user Y connected to communication center 802 through an IP telephony gateway 818 and a second party B, located in the service area of mobile network 806, is recorded by a communication recorder 820 and the recording is stored in a storage facility 822, both resident at communication center 802, which is the communication center in whose service area the user Y is located. During the call, a notifier 824 may provide recording notifications to some or all the parties of the call.

When the users X and Y wish to retrieve recordings of the calls that they requested be recorded, they typically activate communication retriever 810, which, by applying selection criteria established by the respective users, obtains the recordings from the various distributed storage facilities. Thus it is seen that according to user X's selection criteria 826, his calls is retrieved from the storage facility 814, at the communication center serving the service area within which user X was located at the time of the call. Similarly, user Y's call is retrieved according to selection criteria 828 from the storage facility 822.

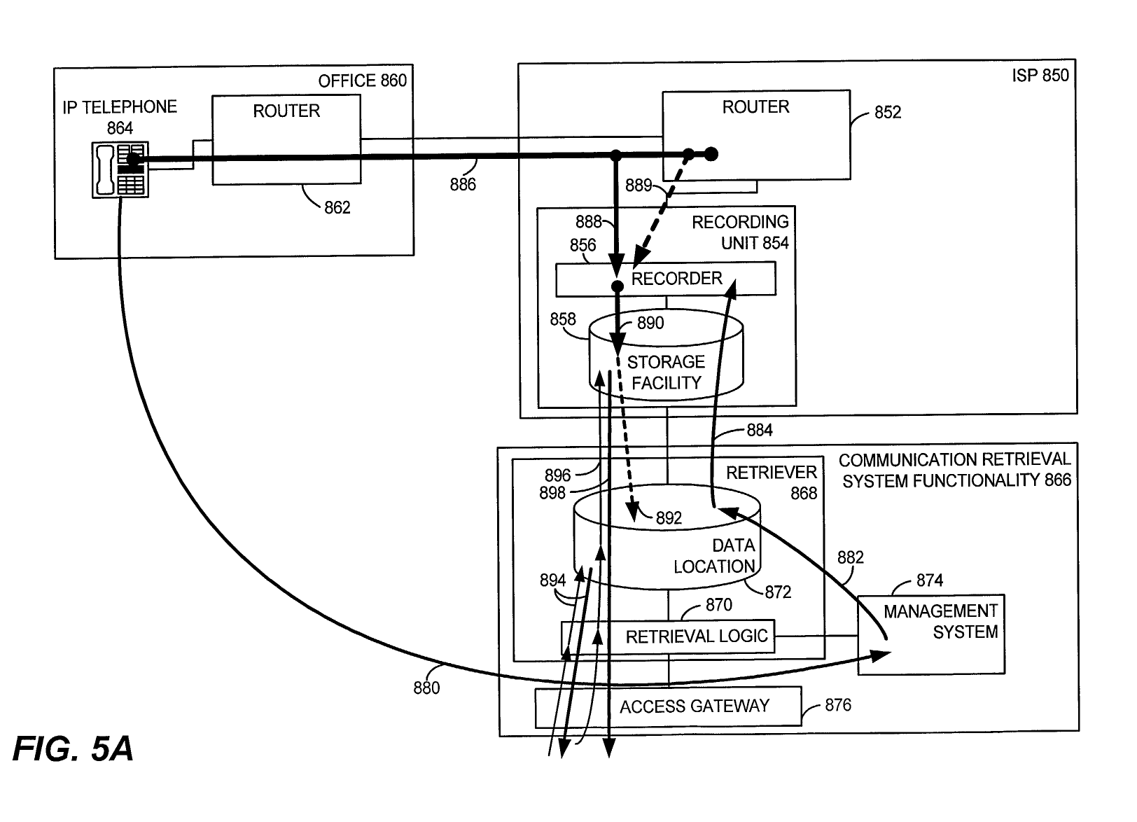

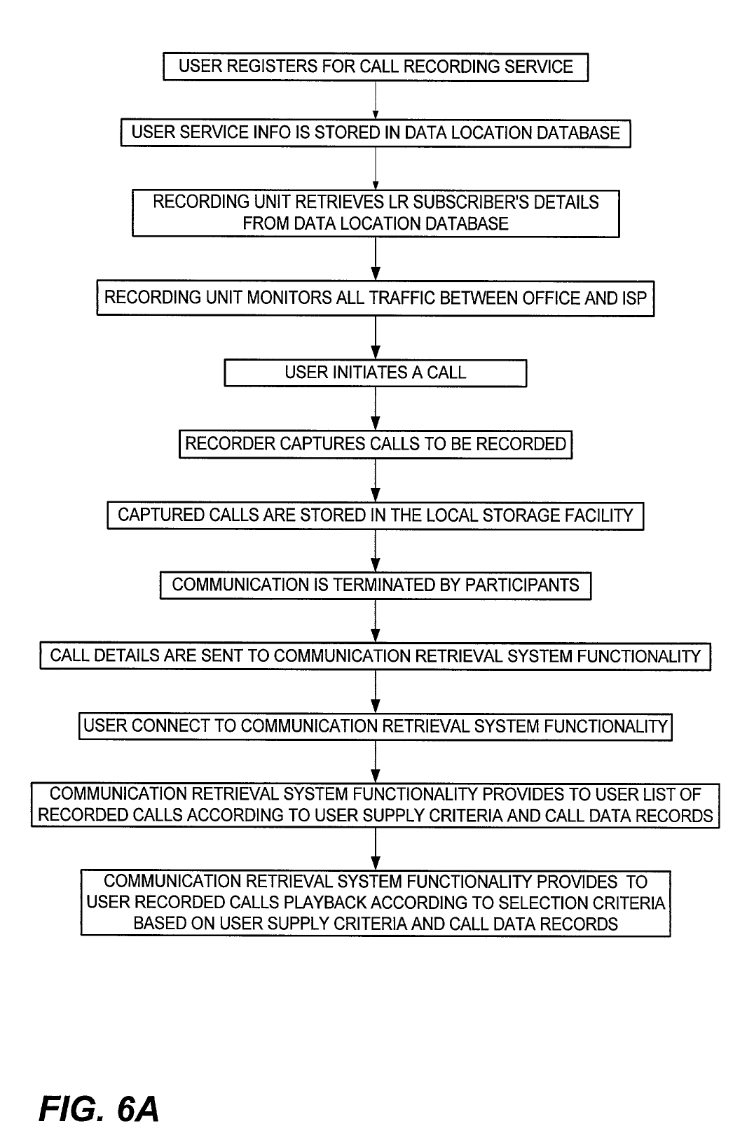

Reference is now made to FIG. 5A which is a simplified functional block diagram illustrating implementations of the functionality of FIG. 4.

FIG. 5A shows the typical general structure of an Internet Service Provider (ISP) center, here designated 850, corresponding to communication center 800 (FIG. 4), including a router 852. In accordance with a preferred embodiment of the present invention, a recording unit 854 is associated with the router 852 and typically includes a communication recorder 856, such as recorder 812 (FIG. 4), which typically receives a communication input from the router 852, records it and stores it in a storage facility 858, such as storage facility 814 (FIG. 4).

The router 852 is typically serving a plurality of offices such as an office 860. Typically resident within the office 860 is a router 862, which serves as a network gateway for plurality of IP telephones 864.

In accordance with a preferred embodiment of the present invention, FIG. 5A also shows a communication retrieval system functionality, designated by reference numeral 866, which may include one or more communication retrievers 868, corresponding to communication retriever 810 (FIG. 4). Communication retriever 866 preferably includes retrieval logic 870 and a data location database 872. Also typically included within communication retrieval system functionality 868 are a management subsystem 874 and an access gateway 876.

The functionality of the embodiment of FIG. 5A may be better understood from the following brief functional description which also relates to the flowchart of FIG. 5A.

Each user, being a person who wishes to have some or all of his calls recorded, may be registered by a suitable communication, designated by reference numeral 880 in FIG. 5A, between IP telephone 864 and management system 874. Upon registration, the management system 874 typically updates data location database 872 by a suitable communication, designated by reference numeral 882 in FIG. 5A and data location 872 typically updates recorder 856 by a suitable communication, designated by reference numeral 884 in FIG. 5A.

During a call, data packets are sent between the IP telephone 864 and router 852, through router 862, by a suitable communication, designated by reference numeral 886 in FIG. 5A. The recorder 856 preferably monitors all of the communications between the IP telephone 864 and the router 852 by a suitable communication, designated by reference numeral 888 in FIG. 5A. The recorder 858 is further operative to capture and to store some or all of the communications data packets of some or every call that was identified as to be recorded in storage facility 858 by a suitable communication, designated by reference numeral 890 in FIG. 5A.

Alternatively, recording unit 854 can be connected to the router 852. The router 852, upon request, in addition to routing the call packages of IP telephone 864, to their destination, will also route them to the recording unit 854 by a suitable communication, designated by reference numeral 889 in FIG. 5A. The recorder 856 within the recording unit 854 will capture these packages and will store them in the storage facility 858.

Upon termination of the call, and alternatively or additionally at the beginning of or during the call, the call details are supplied to communication retrieval system functionality 866 by a suitable communication, designated by reference numeral 892 in FIG. 5A.

A listing, index or any other suitable indication of the calls recorded at the behest of a user may be provided to the user in any suitable format at any suitable time based on the information stored by the communication retrieval system functionality 866. Such listing may be provided based on suitable interactive communications, collectively designated by reference numeral 894 in FIG. 5A.

When the user wishes to receive a playback of a call through his IP telephone 864 or through another terminal, he typically designates the call in data location 872 through access gateway 876 and retrieval logic 870 by suitable communications, collectively designated by reference numeral 896 in FIG. 5A. The traffic of that call is supplied to the user at the user personal extension 864 or other terminal from the storage facility 858 by a suitable communication, designated by reference numeral 898 in FIG. 5A.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

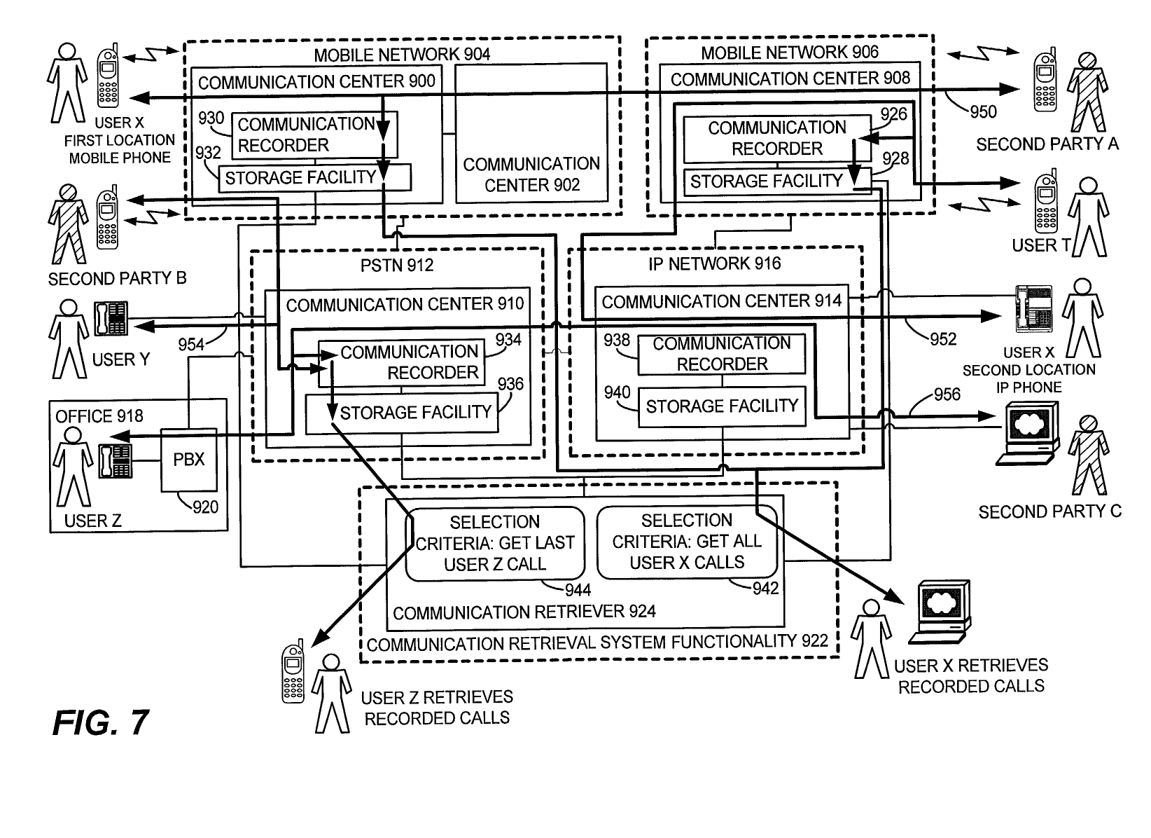

Reference is now made to FIG. 7, which is a simplified partially pictorial functional block diagram illustrating a preferred embodiment of the present invention including a multiplicity of communicators in communication with a plurality of communication centers organized into a plurality of networks and a plurality of communication recorders operative to record communications involving plural ones of the said plurality of networks.

The illustrated embodiment of FIG. 7 is presented in the context of two mobile communication networks in conjunction with a land line communication network and an IP communication network, it is understood that this embodiment of the invention is not limited to those particular types of networks and that particular combination of communication networks and is equally applicable to other suitable types and combinations of communication networks.

In FIG. 7, communication centers 900 and 902 are shown and typically correspond to mobile switching centers in a first mobile network 904, such as a cellular network. A second mobile network 906 shown in FIG. 7 includes a communication center 908. Also shown in FIG. 7 is a communication center 910, which typically corresponds to a network switch in a Public Switched Telephone Network (PSTN) 912 and a communication center 914, which typically corresponds to a switching or routing center in an IP network 916. In accordance with a preferred embodiment of the present invention, each communication center may include, in addition to equipment normally found in a switching or routing center, a communication recorder, which outputs to a storage facility.

Also shown in FIG. 7 as being located within the service area of communication center 910 of PSTN 912, is an office 918 within which a Private Branch Exchange (PBX) 920 is provided.

In accordance with a preferred embodiment of the present invention, also shown in FIG. 7 is a communication retrieval system functionality 922, which includes a communication retriever 924.

For the purposes of illustration of the present invention, FIG. 7 shows recording of a first call, designated by reference numeral 950, between a user X located in the service area of communication center 900 of mobile network 904 and a second party A located in the service area of communication center 908 of mobile network 906. This call is typically recorded by a communication recorder 930 and the recording is stored in a storage facility 932, both resident at communication center 900.

FIG. 7 also shows recording of a second call, designated by reference numeral 952, between a user T located in the service area of communication center 908 of mobile network 906 and the user X, currently located in the service area of communication center 914 of IP network 916. This call is typically recorded by a communication recorder 926 and the recording is stored in a storage facility 928, both resident at communication center 908.

FIG. 7 additionally shows recording of a third call, designated by reference numeral 954, between a user Y located in the service area of communication center 910 of PSTN 912 and a second party B located in the service area of communication center 900 of mobile network 904. This call is typically recorded by a communication recorder 934 and the recording is stored in a storage facility 936, both resident at communication center 910.

FIG. 7 further shows recording of a fourth call, designated by reference numeral 956, between a user Z located in the service area of PBX 920 of office 918 and a second party C located in the service area of communication center 914 of IP network 916. This call is typically recorded by a communication recorder 934 and the recording is stored in a storage facility 936, both resident at communication center 910.

When the users X and Z wish to retrieve recordings of the calls that they requested be recorded, they typically activate communication retriever 924, which, typically by applying selection criteria 942 and 944 established by the respective users, obtains the recordings from the various distributed storage facilities. Thus it is seen that user X's calls are retrieved from the storage facilities 928 and 932, at the respective communication centers serving the service areas within which user X or his second party were located at the time of the calls. Similarly, user Z's call is retrieved from the storage facility 936.

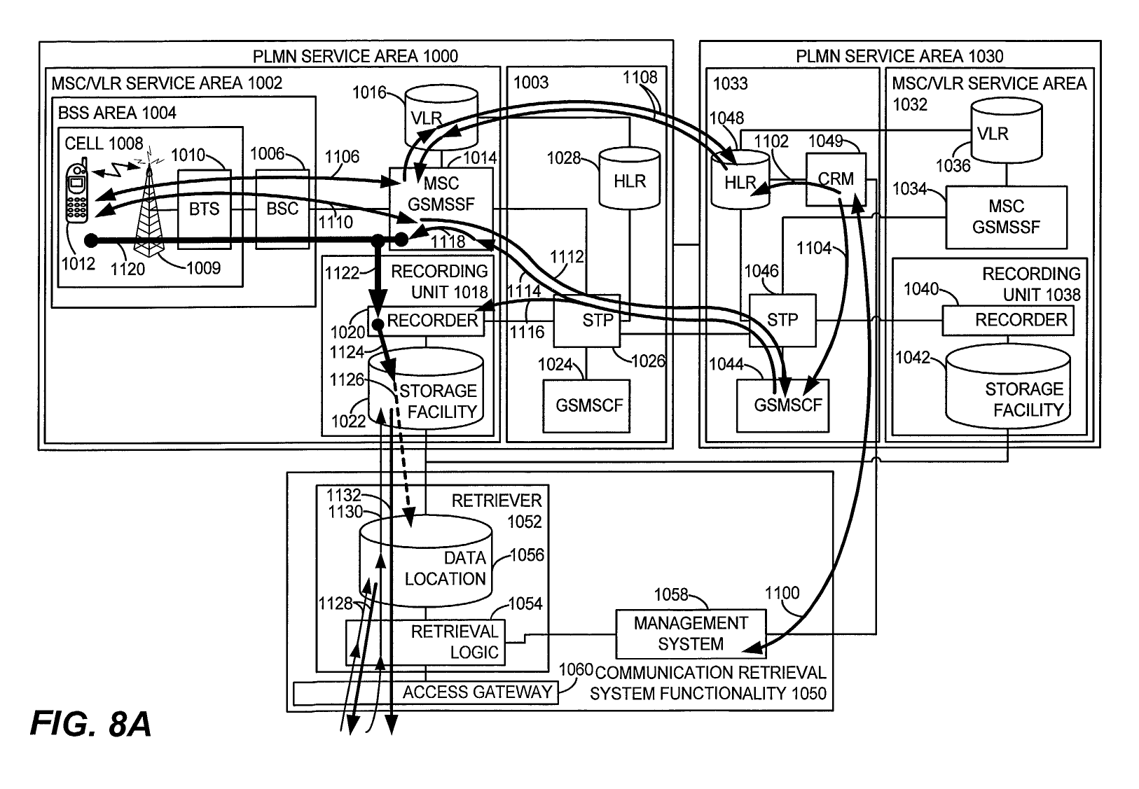

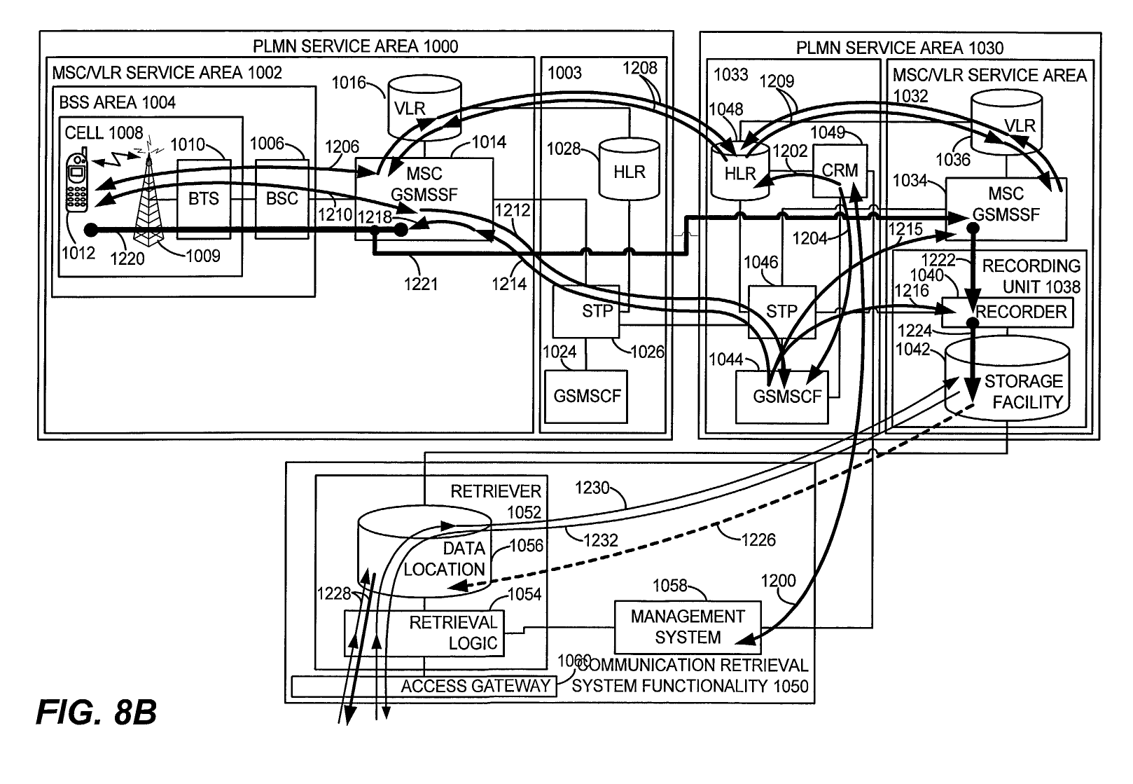

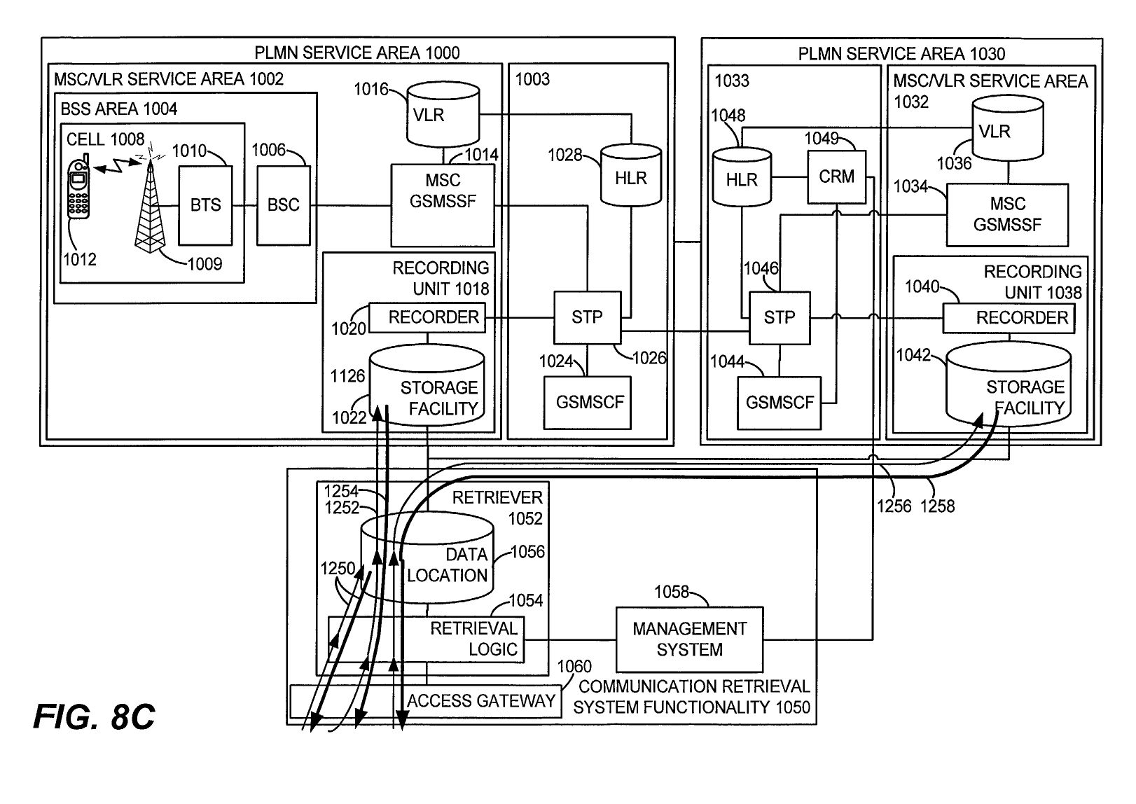

Reference is now made to FIGS. 8A, 8B & 8C which are simplified functional block diagrams illustrating various implementations of the functionality of FIG. 7. All the figures shows the same typical general structure of a first PLMN here designated 1000, comprising at least one communication center here designated 1002, corresponding to communication center 900 (FIG. 7) and additional mobile network functionality here designated 1003, which serves multiple communication centers 1002. FIGS. 8A, 8B & 8C also show part of a second mobile network here designated 1030, comprising a communication center here designated 1032, corresponding to communication center 908 (FIG. 7) and an additional functionality here designated 1033.

Additionally shown is a typical communication retrieval system functionality, here designated 1050, which includes one or more communication retrievers 1052, corresponding to communication retriever 924 (FIG. 7).

Considering the structure of FIGS. 8A, 8B & 8C in greater detail, it is seen that a first PLMN 1000, one example of which is mobile network 904 (FIG. 7) typically includes a plurality of MSC/VLRs service areas 1002 served by functionality 1003.

Within the MSC/VLR service area there are defined a plurality of BSS areas 1004, each including a BSC 1006, which services multiple cells 1008. Each cell typically includes an antenna 1009, which is associated with a BTS 1010 and which services a multiplicity of mobile communicators 1012 when they are located within the service area of each cell.

Also located within the MSC/VLR service area is a MSC 1014, which typically also serves as a Global System for Mobile communication Service Switching Function (GSMSSF) and is coupled to a VLR 1016. In accordance with a preferred embodiment of the present invention, a recording unit 1018 is associated with each MSC 1014 and typically includes a communication recorder 1020, corresponding to recorder 930 (FIG. 7) which typically is operative to receive a copy of MSC 1014 communications, records it and stores it in a storage facility 1022, corresponding to storage facility 932 (FIG. 7).

Functionality 1003 typically includes a Global System for Mobile Communication Service Control Function (GSMSCF) 1024, which provides control inputs via a STP 1026 to MSCs 1014. Functionality 1003 also includes a HLR 1028.

FIG. 8A also shows part of a second PLMN service area 1030, corresponding to mobile network 906 (FIG. 7), which typically includes a plurality of MSC/VLR service areas 1032 served by functionality 1033. Within the MSC/VLR service area 1032 there is provided a MSC 1034, which also serves as a GSMSSF and is coupled to a VLR 1036. In accordance with a preferred embodiment of the present invention, a recording unit 1038 is associated with each MSC 1034 and typically includes a communication recorder 1040, corresponding to recorder 926 (FIG. 7), which preferably receives a communication input from MSC 1034, records it and stores it in a storage facility 1042, corresponding to storage facility 928 (FIG. 7). For the sake of conciseness, BSS area in PLMN 1030 is not shown.

Functionality 1033 typically includes a GSMSCF 1044, which typically provides control inputs via a STP 1046 to both MSCs 1034 within its PLMN service area 1030 and to MSCs in other mobile networks, such as MSC 1014 in PLMN 1000. When serving visited networks, a Customized Applications for Mobile network Enhanced Logic (CAMEL) protocol is typically used. Functionality 1033 also includes a HLR 1048 and a CRM 1049. HLR of the home network is operative to serve in connection with user calls both when the user is within the home network where the HLR is located and when roaming to another network.

Further considering the structure of FIGS. 8A, 8B & 8C, it is seen that communication retrieval system functionality 1050 typically includes communication retriever 1052, which preferably includes retrieval logic 1054 and a data location database 1056. Also typically included within the communication retrieval system functionality 1050 are a management subsystem 1058 and an access gateway 1060.

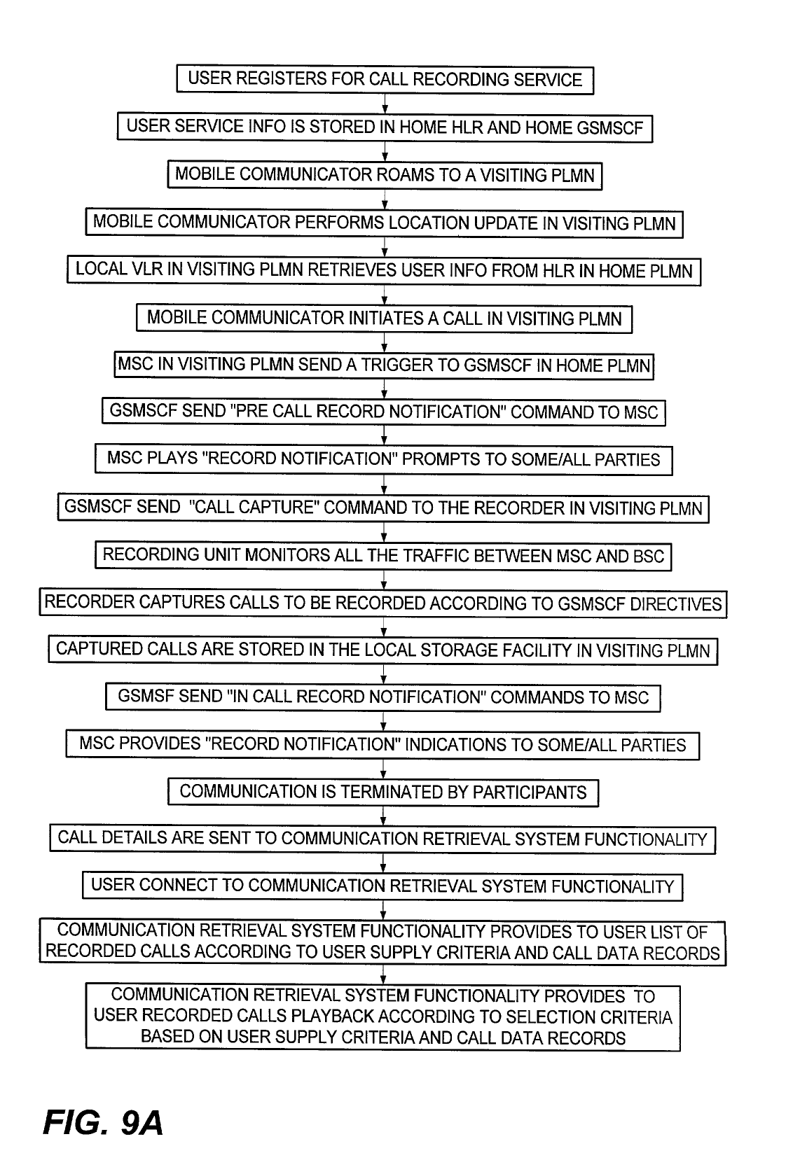

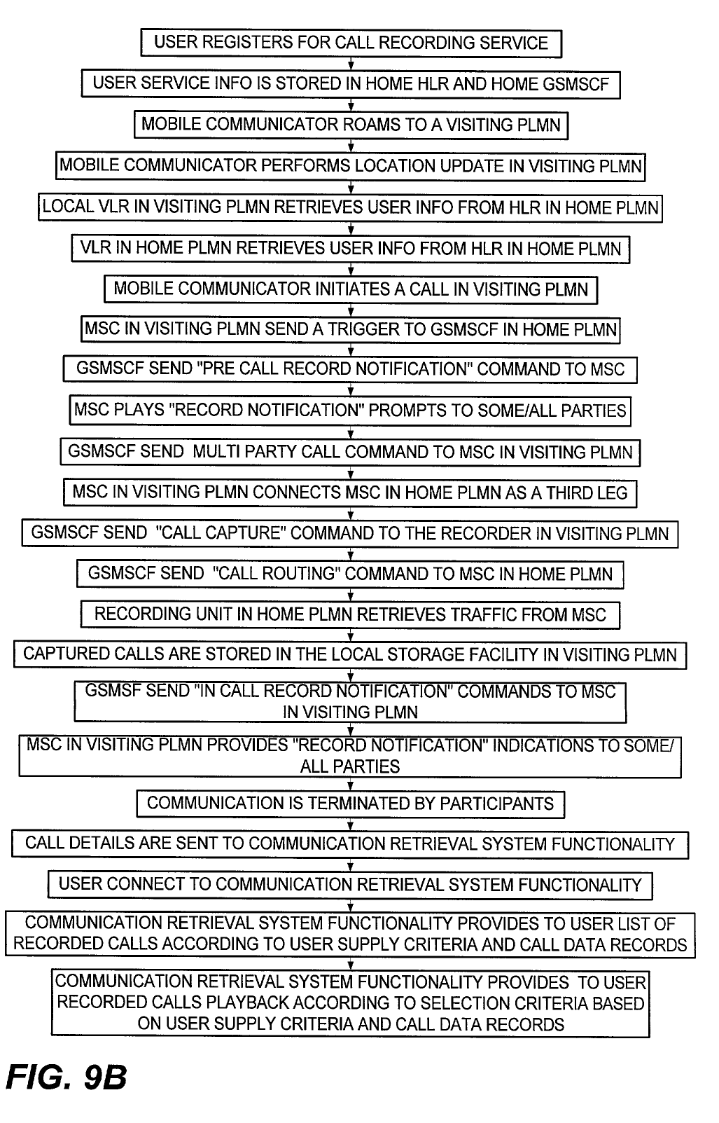

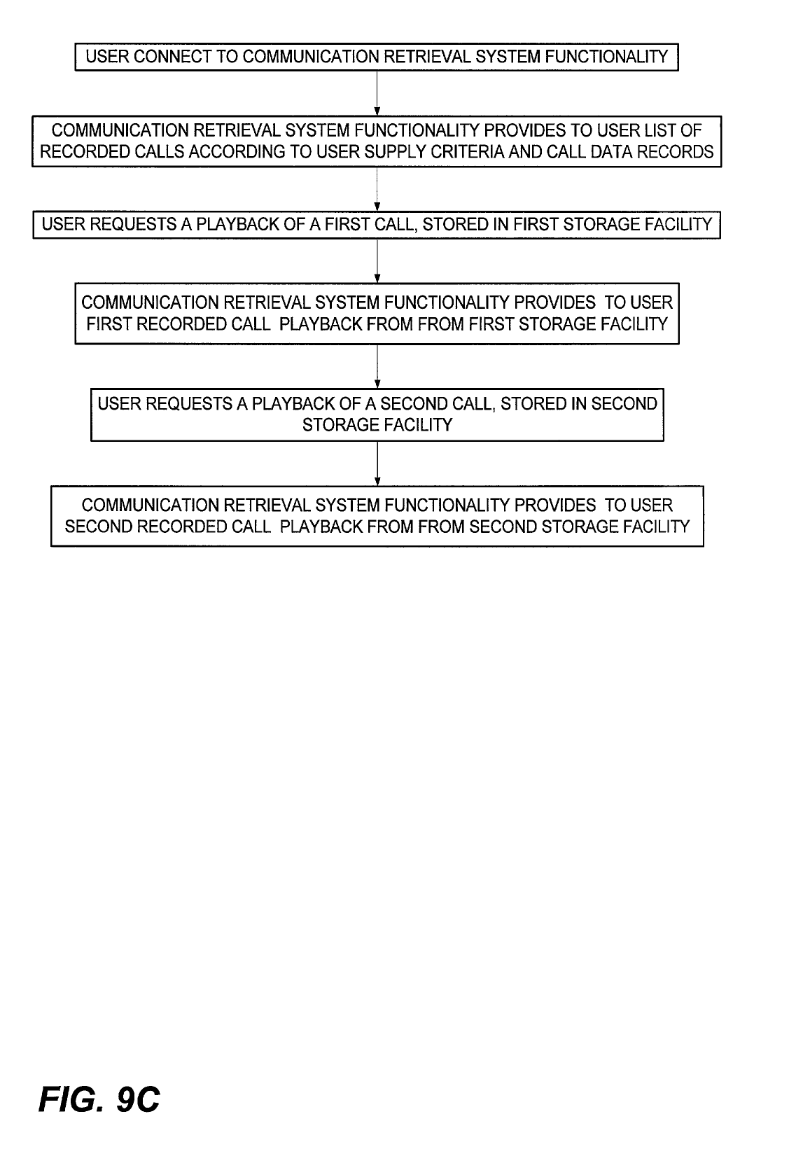

The functionality of the embodiment of FIG. 8A may be better understood from the following brief functional description which also relates to the flowchart of FIG. 9A:

Each user, being a person who wishes to have some or all of his calls recorded, may be registered by a suitable communication, designated by reference numeral 1100 in FIG. 8A, between management subsystem 1060 and CRM subsystem 1049 of his home PLMN 1030. Upon registration, the CRM 1049 updates both HLR 1048, as designated by reference numeral 1102 in FIG. 8A and GSMSCF 1044, as designated by reference numeral 1104 in FIG. 8A.

When the user first operates in the visited PLMN 1000, location update signals are sent between MSC 1014 and mobile communicator 1012, as designated by reference numeral 1106 in FIG. 8A. Those signals also involves the HLR 1048 in the home PLMN 1030 which updates VLR 1016 of each MSC 1014 in the visited PLMN 1000 handling a call for the visiting user by a suitable interactive communications, collectively designated by reference numeral 1108 in FIG. 8A.

Upon initialization of a call involving the mobile communicator 1012, call signals are sent between the mobile communicator 1012 and the MSC 1014 by a suitable communication, designated by reference numeral 1110 in FIG. 8A. The MSC 1014 sends a suitable trigger to the GSMSCF 1044 in the home PLMN 1030 by a suitable communication, designated by reference numeral 1112 in FIG. 8A. The GSMSCF 1044 then may send a “PRE CALL RECORD NOTIFICATION” command to the MSC 1014 by a suitable communication, designated by reference numeral 1114 in FIG. 8A. In response to this command, the MSC 1014 may play “RECORD NOTIFICATION” prompts to some or all of the parties to the call by a suitable communication, designated by reference numeral 1118 in FIG. 8A.

During a call, recorder 1020 in the visited PLMN 1000 is operative to monitor some or all of the traffic between MSC 1014 and mobile communicators 1012 by a suitable communication, designated by reference numeral 1122 in FIG. 8A. In response to a CALL CAPTURE command received from GSMSCF 1044 by a suitable communication, designated by reference numeral 1116 in FIG. 8A, the recorder 1020 is operative to capture typically all of the traffic of every call that it is instructed to record and to store this recorded traffic in storage facility 1022 by a suitable communication, designated by reference numeral 1124 in FIG. 8A.

The GSMSCF 1044 may also send “IN CALL RECORD NOTIFICATION” commands to MSC 1014 by a suitable communication, designated by reference numeral 1114 in FIG. 8A. The MSC 1014 may then provide “RECORD NOTIFICATION” indications to some or all parties to the call by a suitable communication, designated by reference numeral 1118 in FIG. 8A.

Upon termination of the call, and alternatively or additionally at the beginning of or during the call, the call details are supplied to communication retrieval system functionality 1050 by a suitable communication, designated by reference numeral 1126 in FIG. 8A.

A listing, index or any other suitable indication of the calls recorded at the behest of a user may be provided to the user in any suitable format at any suitable time based on the information stored by the communication retrieval system functionality 1050. Such listing may be provided based on suitable interactive communications, collectively designated by reference numeral 1128 in FIG. 8A.

When a user wishes to receive a playback of a call through his mobile communicator 1012 or through another terminal, he typically designates the call in data location 1056 through access gateway 1060 and retrieval logic 1054 by suitable communications, collectively designated by reference numeral 1130 in FIG. 8A. The traffic of that call is preferably supplied to the user at the user mobile communicator 1012 or other terminal from the storage facility 1022 by a suitable communication, designated by reference numeral 1132 in FIG. 8A.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

Reference is now made to FIG. 8B, which differs from that of FIG. 8A in that whereas FIG. 8A shows a visited network recording implementation of the present invention, FIG. 8B shows a home network recording implementation of the present invention.

The embodiment of FIG. 8B may be identical to that of FIG. 8A other than in the following respect:

Recording unit 1018 in the embodiment of FIG. 8A need not be present in the embodiment of FIG. 8B.

The functionality of the embodiment of FIG. 8B may be better understood from the following brief functional description which also relates to the flowchart of FIG. 9B:

Each user, being a person who wishes to have some or all of his calls recorded, may be registered by a suitable communication, designated by reference numeral 1200 in FIG. 8B, between the management subsystem 1058 and CRM subsystem 1049 in his home PLMN 1030. Upon registration, the CRM subsystem 1049 typically updates both HLR 1048, as designated by reference numeral 1202 in FIG. 8B and GSMSCF 1044, as designated by reference numeral 1204 in FIG. 8B.

When a user first operates in the visited PLMN 1000, location update signals are sent between MSC 1014 and mobile communicator 1012, as designated by reference numeral 1206 in FIG. 8B. Those signals also involves the HLR 1048 in the home PLMN 1030 which updates VLR 1016 of each MSC 1014 in the visited PLMN 1000 handling a call for the registered user by suitable interactive communications, collectively designated by reference numeral 1208 in FIG. 8B. The HLR 1048 also updates VLR 1036 of MSC 1034 in the home PLMN 1030 by a suitable interactive communications, collectively designated by reference numeral 1209 in FIG. 8B.

Upon initialization of a call involving the mobile communicator 1012, call signaling takes place between the mobile communicator 1012 and the MSC 1014, as designated by reference numeral 1210 in FIG. 8B. The MSC 1014 typically sends a suitable trigger to GSMSCF 1044 in the home PLMN 1030 by a suitable communication, designated by reference numeral 1212 in FIG. 8B. The GSMSCF 1044 replies preferably by a “MULTI PARTY” command to the MSC 1014 by a suitable communication, designated by reference numeral 1214 in FIG. 8B. In response to this command, the MSC 1014 is operative to transfer, preferably by multi party functionality, to MSC 1034 in the home PLMN 1030 all of the traffic of every call that it is instructed to, by a suitable communication, designated by reference numeral 1221 in FIG. 8B.

Within the home PLMN 1030, the GSMSCF 1044 may send a CALL ROUTING command to the MSC 1034, as designated by reference numeral 1215 in FIG. 8B. In response, the MSC 1034 is typically operative to route the call traffic to the recorder 1040, as designated by reference numeral 1222 in FIG. 8B. The GSMSCF 1044 is also operative to send a CALL CAPTURE command to recorder 1040 in the home PLMN 1030, as designated by reference numeral 1216 in FIG. 8B. Consequently, the recorder 1040 is operative to capture and to store some or all of the traffic of every call that it is instructed to in storage facility 1042, as designated by reference numeral 1224 in FIG. 8B.

During the call, the GSMSCF 1044 may also send “IN CALL RECORD NOTIFICATION” commands to MSC 1014 by a suitable communication, designated by reference numeral 1214 in FIG. 8B. The MSC 1014 may then provide “RECORD NOTIFICATION” indications to some or all parties to the call by a suitable communication, designated by reference numeral 1218 in FIG. 8B.

Upon termination of the call, and alternatively or additionally at the beginning of or during the call, the call details are typically supplied to communication retrieval system functionality 1050 by a suitable communication, designated by reference numeral 1226 in FIG. 8B.

A listing, index or any other suitable indication of the calls recorded at the behest of a user may be provided to the user in any suitable format at any suitable time based on the information stored by the communication retrieval system functionality 1050. Such listing may be provided based on suitable interactive communications, collectively designated by reference numeral 1228 in FIG. 8B.

When a user wishes to receive a playback of a call through his mobile communicator 1012 or through another terminal, he typically designates the call in data location 1056 through access gateway 1060 and retrieval logic 1054 by suitable communications, collectively designated by reference numeral 1230 in FIG. 8B. The traffic of that call is supplied to the user at the user mobile communicator 1012 or other terminal from the storage facility 1042 by a suitable communication, designated by reference numeral 1232 in FIG. 8B.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

It is understood that this embodiment of the invention is not limited to a creation of multiparty call by the visiting MSC 1014, with the home MSC 1034, where a recording unit 1038 is operative and is equally applicable to a creation of call forwarding from the visiting MSC 1014, to another MSC, where another recording unit is installed and is operative to record said forwarded call and where said MSC also forwards said call to its original destination.

Reference is now made to FIG. 8C, which differs from that of FIG. 8A in that whereas FIG. 8A shows a visited network recording implementation of the present invention, FIG. 8C shows a retrieval from multiple networks implementation of the present invention.

The embodiment of FIG. 8C may be identical to that of FIG. 8A, however the functionality thereof is different.

The functionality of the embodiment of FIG. 8C may be better understood from the following brief functional description which also relates to the flowchart of FIG. 9C:

A listing, index or any other suitable indication of some or all the calls recorded at the behest of a user, typically while being served by either his home network or while visiting another network, may be provided to the user in any suitable format at any suitable time based on the information stored by communication retrieval system functionality 1050. Such listing may be provided based on suitable interactive communications, collectively designated by reference numeral 1250 in FIG. 8C.

When a user wishes to receive a playback of a call performed while visiting PLMN 1000 through his mobile communicator 1012 or through another terminal, he typically designates the call in data location 1056 through access gateway 1060 and retrieval logic 1054 by suitable communications, collectively designated by reference numeral 1252 in FIG. 8C.

The traffic of that call is supplied to the user at the user mobile communicator 1012 or other terminal from the storage facility 1022 by a suitable communication, designated by reference numeral 1254 in FIG. 8C.

Similarly, when a user wishes to receive a playback of a call performed while being served by his home PLMN 1030 through his mobile communicator 1012 or through another terminal, he preferably designates the call in data location 1056 through access gateway 1060 and retrieval logic 1054 by suitable communications, collectively designated by reference numeral 1256 in FIG. 8C.

The traffic of that call is typically supplied to the user at the user mobile communicator 1012 or other terminal from the storage facility 1042 by a suitable communication, designated by reference numeral 1258 in FIG. 8C.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

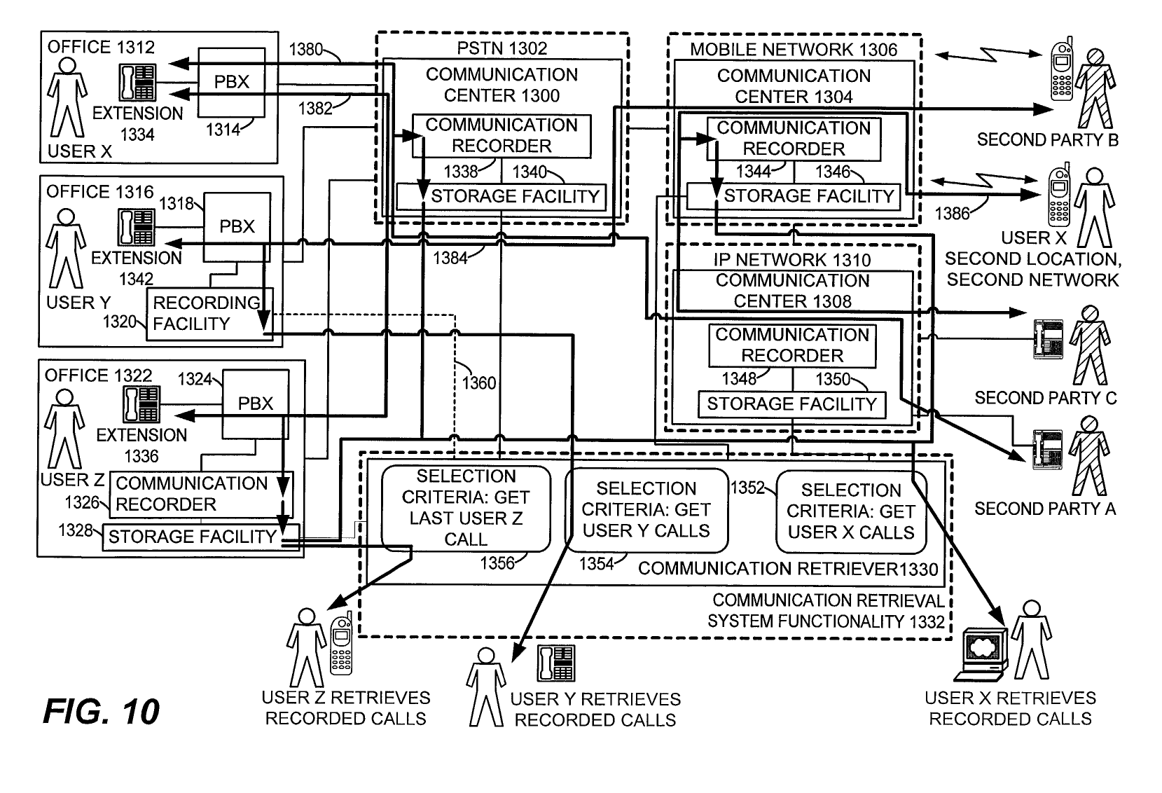

Reference is now made to FIG. 10, which is a simplified partially pictorial functional block diagram illustrating a preferred embodiment of the present invention including a multiplicity of communicators in communication with a plurality of communications centers serving at least one PBX and a plurality of communication recorders.

The illustrated embodiment of FIG. 10 is presented in the context of a landline communication network serving three different offices, each equipped with a PBX, in conjunction with a mobile communication network and an IP communication network. It is understood that this embodiment of the invention is not limited to this particular combination of communication networks and PBXs and is equally applicable to other suitable types and combinations of communications networks and PBXs.

In FIG. 10, a communication center 1300 is shown and typically corresponds to a network switch in a PSTN 1302. FIG. 10 also shows a communication center 1304, which typically corresponds to a mobile switching center in a mobile network 1306. FIG. 10 additionally shows a communication center 1308, which typically corresponds to a router in an IP network 1310. Also shown in FIG. 10 as being located within the service area of communication center 1300 of PSTN 1302 is an office 1312 within which a PBX 1314 is provided, an office 1316 within which a PBX 1318 and a associated recording facility 1320 is provided and an office 1322 within which a PBX 1324 is provided.

In accordance with a preferred embodiment of the present invention, each communication center may include, in addition to equipment normally found in a switching center, a communication recorder, which outputs to a storage facility. Similarly, office 1322 may include, in addition to equipment normally found in an office, a communication recorder 1326, which outputs to a storage facility 1328.

In accordance with a preferred embodiment of the present invention, also shown in FIG. 10 is a communication retrieval system functionality 1332, which includes a communication retriever 1330.

For the purposes of illustration of the present invention, FIG. 10 shows recording of a first call, designated by reference numeral 1380, between a user X located within the premises of office 1312 and using an extension 1334 of PBX 1314, and a second party A, located in the service area of communication center 1308 of IP network 1310. This call is typically recorded by a communication recorder 1338 and the recording is stored in a storage facility 1340, both resident at communication center 1300.

FIG. 10 also shows recording of a second call, designated by reference numeral 1382, between the user X located in the premises of office 1312 and using extension 1334 of PBX 1314, and a user Z located in the premises of office 1322, using an extension 1336 of PBX 1324. This call is typically recorded at a single location, for the benefit of the two users, by a communication recorder 1326 and the recording is stored in a storage facility 1328, both resident at the office 1322.

FIG. 10 additionally shows recording of a third call, designated by reference numeral 1384, between a user Y located in the premises of office 1316, using an extension 1342 of PBX 1318, and a second party B, located in the service area of communication center 1304 of mobile network 1306. This call is typically recorded by recording facility 1320, resident at office 1316.

FIG. 10 further shows recording of a fourth call, designated by reference numeral 1386, between the user X, currently located in the service area of communication center 1304 of mobile network 1306 and a second party C located in the service area of communication center 1308 of IP network 1310. This call is typically recorded by a communication recorder 1344 and the recording is stored in a storage facility 1346, both resident at communication center 1304.

When the users X, Y and Z wish to retrieve recordings of the calls, which they requested be recorded, they typically activate communication retriever functionality 1330, which, by applying selection criteria 1352, 1354 and 1356 established by the respective users and by preferably implementing a cross network user identification functionality, obtain the recordings from the various distributed storage facilities. Thus it is seen that user X's calls are retrieved from the storage facilities 1340, 1328 and 1346, at the respective communication centers serving the service areas within which the user X or his second party were located at the time of the calls. Similarly, user Y's call is retrieved from the recording facility 1320 through an interface 1360 between the communication retriever 1332 and the recording facility 1320 and user Z's call is retrieved from the storage facility 1328.

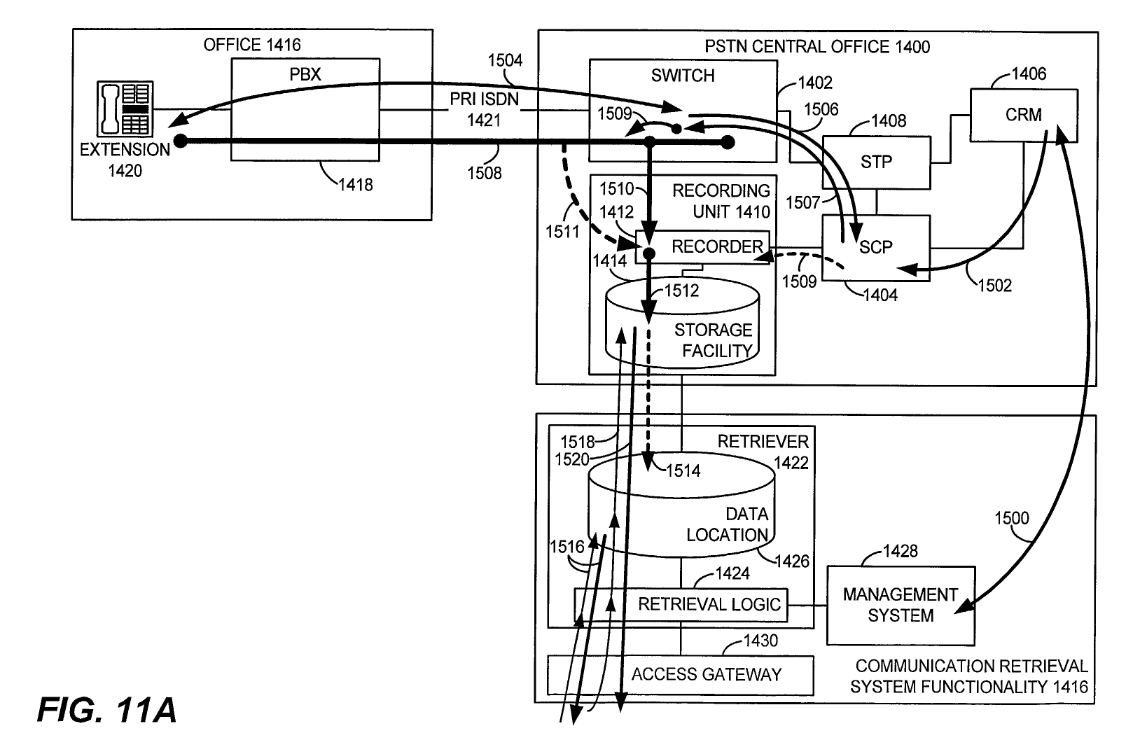

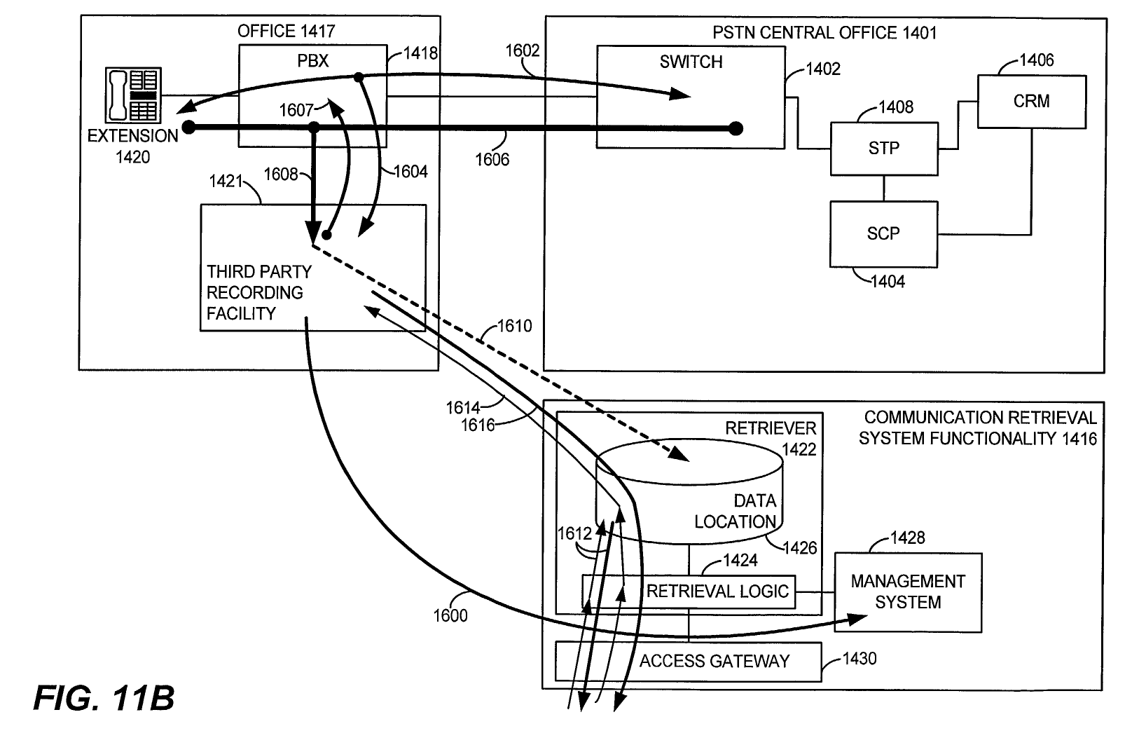

Reference is now made to FIGS. 11A and 11B which are simplified functional block diagrams illustrating various implementations of the functionality of FIG. 10. Both FIGS. 11A and 11B shows the same typical general structure of a communication center here designated 1400, corresponding to communication center 1302 (FIG. 10), serving a PBX resident at an external office. The structure of FIGS. 11A & 11B also includes a communication retrieval system functionality here designated 1416, which includes one or more communication retrievers 1422, corresponding to communication retriever 1330 (FIG. 10).

Considering the structure of FIGS. 11A & 11B in greater details, it is seen that PSTN 1400, corresponding to PSTN 1302 (FIG. 10), includes a switch 1402, coupled to a SCP 1404 and to a CRM 1406 through a STP 1408. In accordance with a preferred embodiment of the present invention, a recording unit 1410 is associated with the switch 1402 and typically includes a communication recorder 1412, such as recorder 1338 (FIG. 10) which receives a communication input from the switch 1402, records it and stores it in a storage facility 1414, such as storage facility 1340 (FIG. 10).

The switch 1402 is typically serving a plurality of offices such as an office 1416, corresponding to office 1312 (FIG. 10). Resident within office 1416 is a PBX 1418, corresponding to PBX 1314 (FIG. 10), which in turn is serving a plurality of extensions 1420 such as extension 1334 in FIG. 10. The connection between the PBX 1428 and the switch 1402 is preferably by a Integrated Services Digital Network Primary Rate Interface (ISDN PRI) line protocol, here designated 1421.

Communication retriever 1422 preferably includes retrieval logic 1424 and a data location database 1426. Communication retrieval system functionality 1428 typically further includes a management subsystem 1058 and an access gateway 1430.

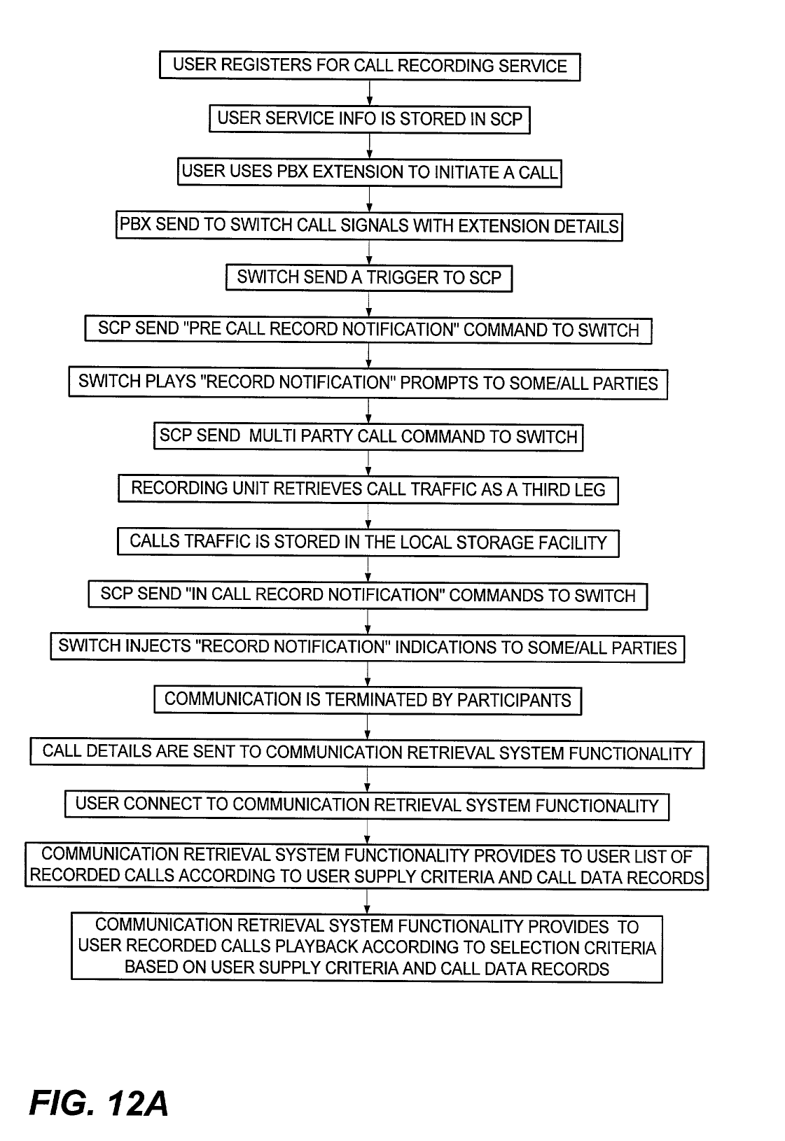

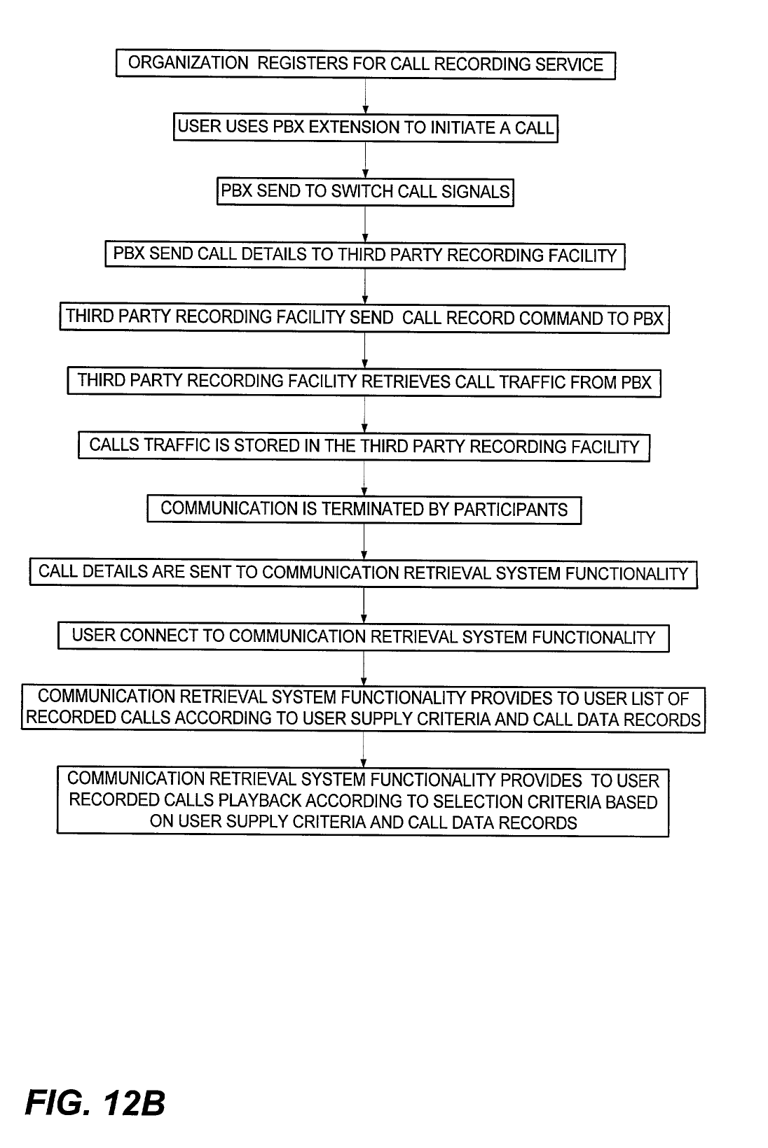

The functionality of the embodiment of FIG. 11A may be better understood from the following brief functional description which also relates to the flowchart of FIG. 12A:

Each user, being a person who wishes to have some or all of his calls recorded, may be registered by a suitable communication, designated by reference numeral 1500 in FIG. 11A, between the management subsystem 1428 and CRM 1406 of PSTN 1400. Upon registration, the CRM 1406 updates SCP 1404 by a suitable communication, designated by reference numeral 1502 in FIG. 11A.

Upon initialization of a call, call signals are sent between extension 1420 and switch 1402, through PBX 1418, by a suitable communication, designated by reference numeral 1504 in FIG. 11A. This communication, preferably based on ISDN PRI 1421 protocol, typically send the PBX extension number being used to the switch 1402. Consequently, the switch 1402 sends a suitable trigger to the SCP 1404 by a suitable communication, designated by reference numeral 1506 in FIG. 11A. The SCP 1404 then may send a “PRE CALL RECORD NOTIFICATION” command to the switch 1402 by a suitable communication, designated by reference numeral 1507 in FIG. 11A. In response to this command, the switch 1402 may play “RECORD NOTIFICATION” prompts to some or all of the parties to the call by a suitable communication, designated by reference numeral 1508 in FIG. 11A.

Before or during a call, the SCP 1404 may send to the switch 1402 a MULTI PARTY command, designated by reference numeral 1507 in FIG. 11A. In response, the switch 1402 is operative to transfer to recorder 1412, preferably by multi party functionality, all of the traffic of every call that it is instructed to by a suitable communication, designated by reference numeral 1510 in FIG. 11A. The recorder 1412 is typically operative to store the recorded traffic in storage facility 1414 by a suitable communication, designated by reference numeral 1512 in FIG. 11A.

The SCP 1404 may also send “IN CALL RECORD NOTIFICATION” commands to the switch 1402 by a suitable communication, designated by reference numeral 1507 in FIG. 11A. The switch 1402 may then typically provide “RECORD NOTIFICATION” indications to some or all parties to the call by a suitable communication, designated by reference numeral 1509 in FIG. 11A.

Alternatively, instead of connecting the recorder unit 1410 to the switch 1402 via communication 1510, the recorder unit 1410 can be connected to the communication line 1508 between the PBX 1418 and the switch 1508 via communication here designated 1511. In this embodiment of the current invention, the SCP 1404, instead of commanding the switch 1402 to create a multiparty call, commands the recorder 1412 via communication 1509 to record said extension 1420 call as being transferred via communication 1508.

Upon termination of the call, and alternatively or additionally at the beginning of or during the call, the call details are preferably supplied to communication retrieval system functionality 1416 by a suitable communication, designated by reference numeral 1514 in FIG. 11A.

A listing, index or any other suitable indication of the calls recorded at the behest of a user may be provided to the user in any suitable format at any suitable time based on the information stored by the communication retrieval system functionality 1416. Such listing may be provided based on suitable interactive communications, collectively designated by reference numeral 1516 in FIG. 11A.

When the user wishes to receive a playback of a call through his personal extension 1420 or through another terminal, he typically designates the call in data location 1426 through access gateway 1430 and retrieval logic 1424 by suitable communications, collectively designated by reference numeral 1518 in FIG. 11A. The traffic of that call is typically supplied to the user at the user personal extension 1420 or other terminal from the storage facility 1414 by a suitable communication, designated by reference numeral 1520 in FIG. 11A.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

Reference is now made to FIG. 11B, which differs from that of FIG. 11A in that whereas FIG. 8A shows a network based recording implementation of the present invention, FIG. 11B shows a PBX recording facility in conjunction with network management and retrieval facility implementation of the present invention.

The embodiment of FIG. 11B may be identical to that of FIG. 11A other than in the following respects:

Recording unit 1410 in the embodiment of FIG. 11A need not be present in the embodiment of FIG. 11B.

A third party recording facility 1421 is present within the premises of office 1417 and is operative to locally record calls from PBX 1418.

The functionality of the embodiment of FIG. 11B may be better understood from the following brief functional description which also relates to the flowchart of FIG. 12B:

Each organization who wishes to have some or all of his calls recorded, may be registered by a suitable communication, designated by reference numeral 1600 in FIG. 11B, between the management subsystem 1428 and third party recording facility 1421.

Upon initialization of a call, call signals are sent between extension 1420 and switch 1402, through PBX 1418, by a suitable communication, designated by reference numeral 1602 in FIG. 1B. The PBX 1418 also sends call details to third party recording facility 1421 by a suitable communication, designated by reference numeral 1604 in FIG. 11B.

During a call, call traffic is sent between extension 1420 and the switch 1402, through PBX 1418, by a suitable communication, designated by reference numeral 1606 in FIG. 11B. In response to a preferable CALL RECORD command from the third party recording facility 1421 by a suitable communication designated by reference numeral 1607 in FIG. 11B, the PBX 1418 is operative to route a copy of the call to be recorded to the third party recording facility 1421 by a suitable communication, designated by reference numeral 1608 in FIG. 11B. In turn, the third party recording facility 1421 is preferably operative to capture all of the traffic of every call that was received as to be recorded and to store this recorded traffic internally.

Upon termination of the call, and alternatively or additionally at the beginning of or during the call, the call details are supplied to communication retrieval system functionality 1416 by a suitable communication, designated by reference numeral 1610 in FIG. 11B.

A listing, index or any other suitable indication of the calls recorded at the behest of a user may be provided to the user in any suitable format at any suitable time based on the information stored by the communication retrieval system functionality 1416. Such listing may be provided based on suitable interactive communications, collectively designated by reference numeral 1612 in FIG. 11B.

When a user wishes to receive a playback of a call through his personal extension 1420 or through another terminal, he typically designates the call in data location 1426 through access gateway 1430 and retrieval logic 1424 by suitable communications, collectively designated by reference numeral 1614 in FIG. 11B. The traffic of that call is typically supplied to the user at the user personal extension 1420 or other terminal from the third party recording facility 1421 by a suitable communication, designated by reference numeral 1616 in FIG. 11B.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

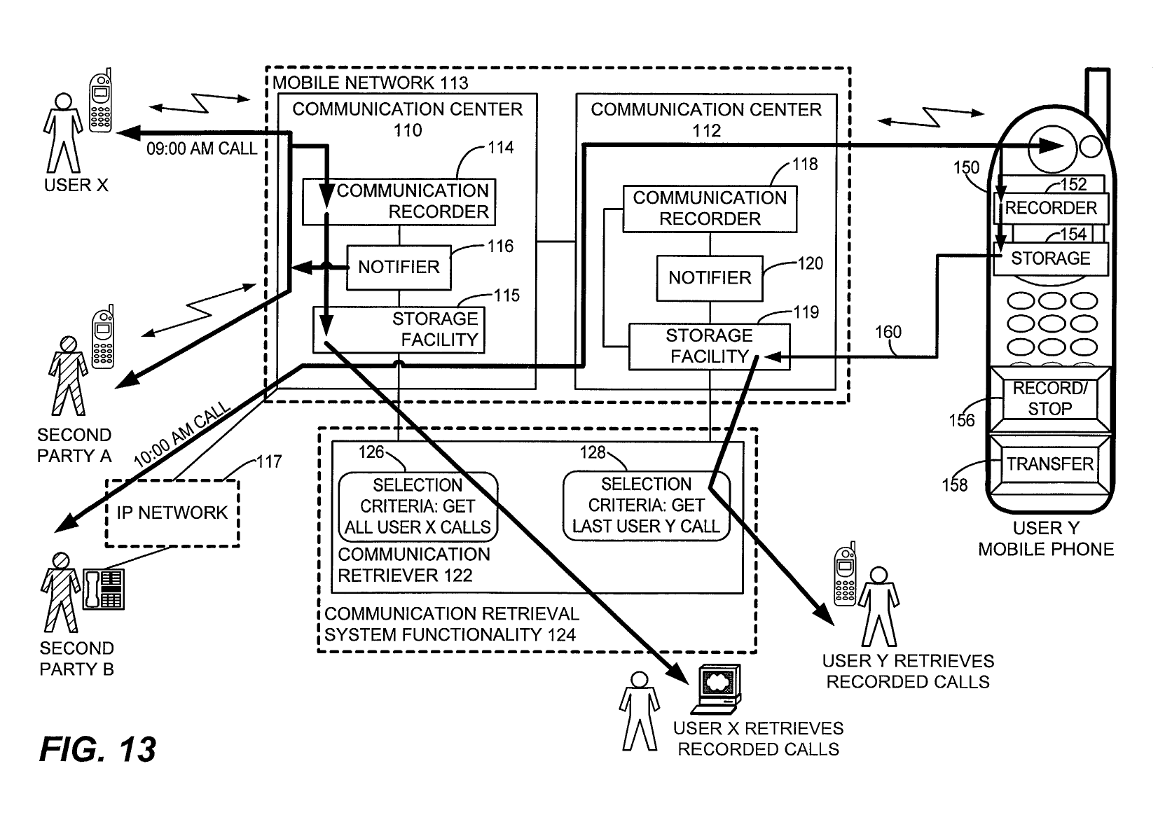

Reference is now made to FIG. 13, which is a simplified partially pictorial functional block diagram illustrating a preferred embodiment of the present invention including a multiplicity of communicators in communication with a plurality of communications centers including a plurality of network based and communicator based communication recorders.

The embodiment of FIG. 13 may be identical to that of FIG. 1 other than in the following respect:

FIG. 13 also shows a mobile communicator, designated here by reference numeral 150. In accordance with a preferred embodiment of the present invention, mobile communicator 150 includes, in addition to equipment normally found in a mobile communicator, an internal communication recorder, here designated 152, operative to store communication on an internal storage, here designated 154, and capable to receive manual commands from a record/stop apparatus 156. In addition, a transfer apparatus, designated here by reference numeral 158 is operative to initiate a transfer of recorded calls preferably from the mobile communicator 150 to network based storage facility 119 by suitable communication, here designated by reference numeral 160.

For the purposes of illustration of the present invention, FIG. 13 shows recording of a 9:00 AM call, between a user X and a second party A, which is handled entirely by first communication center 110. This call is recorded by communication recorder 114 and the recording is stored in storage facility 115, both resident at communication center 110. During the call, notifier 116 may provide recording notifications to some or all the parties of the call.

A 10:00 AM call, between a user Y using mobile communicator 150 and located in the service area of communication center 112 and a second party B, located in the service area of IP network 117, is recorded by recorder 152 and the recording is stored in storage 154, both located at the mobile communicator 150.

During the call or after it being terminated, a manually or automatic triggered communication, here designated 160, enables transfer of the recorded call from the mobile communicator 150 to the storage facility 119 located at the communication centers serving the area within which the user Y is currently located.

When the users X and Y wish to retrieve recordings of the calls that they requested be recorded, they activate communication retriever 122, which, by applying selection criteria 126 and 128 established by the respective users, obtain the recordings from the various distributed storage facilities. Thus it is seen that user X's call is retrieved from the storage facility 115, located at the communication center serving the service area within which the user X was located at the time of the call. Similarly, user Y's call is retrieved from the storage facility 119, located at the communication center serving the service area within which the user Y was located after the call and to which the call recording was transferred from the mobile communicator 150.

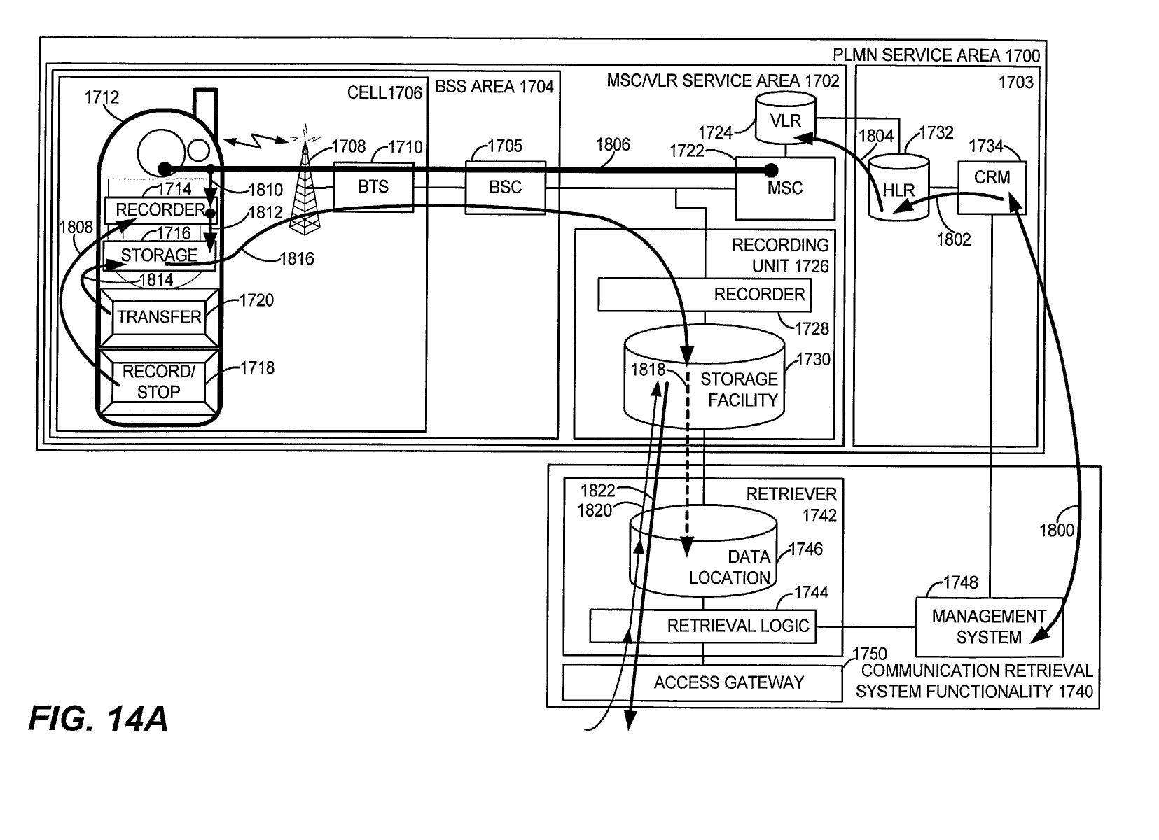

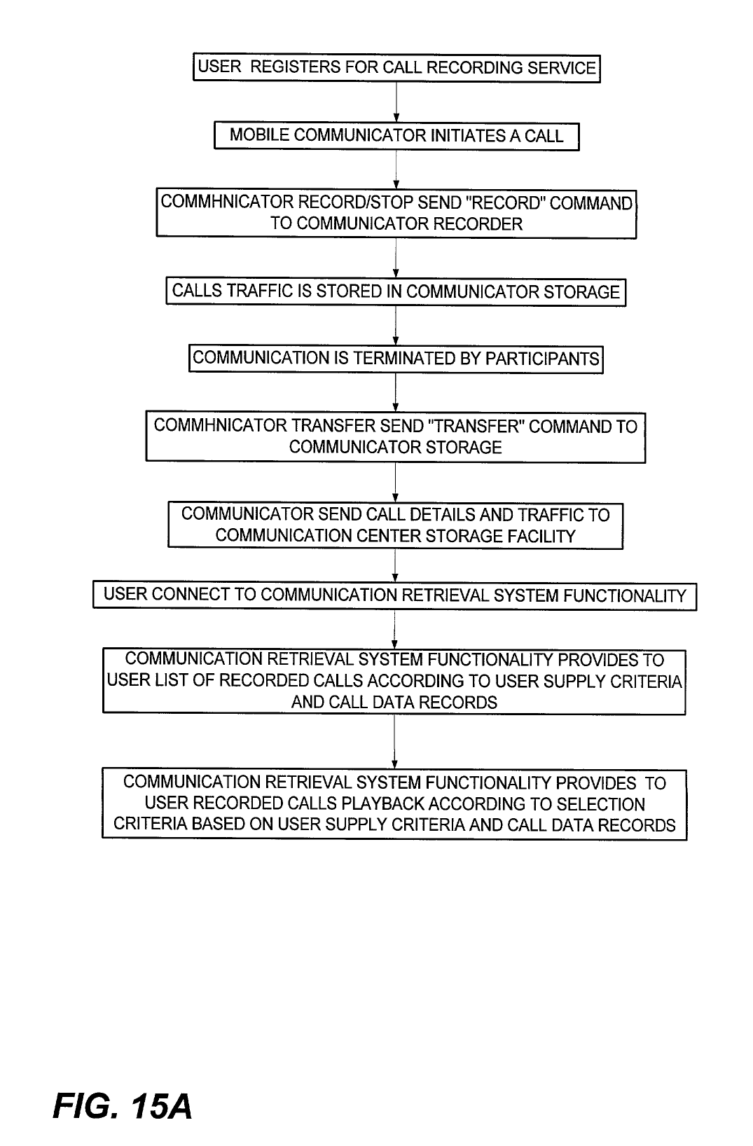

Reference is now made to FIG. 14A which is a simplified functional block diagram illustrating implementation of the functionality of FIG. 13.

Turning to FIG. 14A, it is seen that a PLMN 1700, which corresponds to the service area of mobile network 113 (FIG. 13) typically includes a plurality of MSC/VLR service areas 1702 served by functionality 1703.

Within the MSC/VLR service area there are defined a plurality of BSS areas 1704 and typically including a BSC 1705, which services multiple cells 1706. Each cell typically includes an antenna 1708, which is associated with a BTS 1710 and which services a multiplicity of mobile communicators 1712 when they are located within the service area of each cell.

In accordance with a preferred embodiment of the present invention, mobile communicator 1712, corresponding to recorder 150 (FIG. 13), includes, in addition to equipment normally found in a mobile communicator, recorder 1714, corresponding to recorder 152 (FIG. 13), operative to store communication on storage 1716, corresponding to storage 154 (FIG. 13). Recorder 1714 is also preferably capable of receiving manual commands from a record/stop 1718, corresponding to record/stop 156 (FIG. 13). Mobile communicator 1708 also includes a transfer 1720, corresponding to transfer 158 (FIG. 13), which is operative to initiate two ways transfer of recorded calls.

Also located within the MSC/VLR service area is a MSC 1722, which is coupled to a VLR 1724. In accordance with a preferred embodiment of the present invention, a recording unit 1726 is associated with each MSC 1722 and typically includes a communication recorder 1728, corresponding to recorder 114 (FIG. 13), which receives a communication input from MSC 1722, records it and stores it in a storage facility 1730, corresponding to storage facility 115 (FIG. 13). A HLR 1732 serves as a network wide location database and is associated with a CRM 1734.

In accordance with a preferred embodiment of the present invention, FIG. 14A also shows a communication retrieval system functionality, designated by reference numeral 1740, which includes one or more communication retrievers 1742, corresponding to communication retriever 122 (FIG. 13).

Communication retriever 1742 preferably includes retrieval logic 1744 and a data location database 1746. Also typically included within communication retrieval system functionality 1740 are a management subsystem 1748 and an access gateway 1750.

The functionality of the embodiment of FIG. 14A may be better understood from the following brief functional description which also relates to the flowchart of FIG. 14A:

Each user, being a person who wishes to have some or all of his calls recorded, may be registered by a suitable communication, designated by reference numeral 1800 in FIG. 14A, between management subsystem 1748 and CRM 1734. Upon registration, the CRM 1734 updates HLR 1732 by a suitable communication, designated by reference numeral 1802 in FIG. 14A. As necessary, the HLR 1732 updates VLR 1724 of each MSC 1722 handling a call for the registered user by a suitable communication, designated by reference numeral 1804 in FIG. 14A.

During a call, call traffic is being transferred between mobile communicator 1712 and MSC 1722 by suitable communication, designated by reference numeral 1806 in FIG. 14A. Before or during the call, automatic or user triggered record/stop 1720 may send to recorder 1714 a RECORD command by suitable communication, designated by reference numeral 1808 in FIG. 14A. In response, the recorder 1714 is preferably operative to capture the call traffic by a suitable communication, designated by reference numeral 1810 in FIG. 14A and to store it in storage 1716 by a suitable communication, designated by reference numeral 1812 in FIG. 14A.

Upon termination of the call, and alternatively or additionally at the beginning of or during the call, automatic or user triggered transfer 1720 may send to the storage 1716 a TRANSFER command by a suitable communication, designated by reference numeral 1814 in FIG. 14A. Consequently, the storage 1716 is operative to transfer the call recording to storage facility 1730 resident at the communication center serving the service area within which the mobile communicator 1712 is located, by a suitable wireless communication, designated by reference numeral 1816 in FIG. 14A.

Alternatively, said call recording may be transferred from the mobile communicator storage 1716 to the network storage facility 1730 by other suitable types of communications. Such alternative may be using a Universal Serial Bus (USB) cable communication or Bluetooth wireless communication between the mobile communicator 1712 and typically a personal computer, and preferably through a landline communication such as IP network to the storage facility 1730.

The call details are thereafter supplied to communication retrieval system functionality 1740 by a suitable communication, designated by reference numeral 1818 in FIG. 14A.

When a user wishes to receive a playback of a call through his mobile communicator 1712 or through another terminal, he typically designates the call in data location 1746 through access gateway 1750 and retrieval logic 1744 by suitable interactive communications, collectively designated by reference numeral 1820 in FIG. 14A. The traffic of that call is supplied to the user at the user mobile communicator 1712 or other terminal from the storage facility 1730 by a suitable communication, designated by reference numeral 1822 in FIG. 14A.

Preferably, user call recordings remain stored in the recording system until retrieved by the user or until expiration of a predetermined extended period of time or until a predetermined number of calls has been exceeded or until a predetermined cumulate duration of calls has been exceeded, additional or alternative to any other suitable type of criteria, preferably set by the user.

It is appreciated that the network based recording embodiments of the present invention are typically capable of enabling a user to predefine a criteria for calls to be recorded. Typical definitions can be record all calls record only call from and to certain phone numbers and record calls which are designated as to be recorded by users, before or during the call . Setting such criteria is typically done at the time of the registration with the recording service.

It is further appreciated that the network based recording embodiments of the present invention can typically respond to user inputs before, during and after a call. Such user inputs can typically be at least one key pressed at a user's communication terminal, or via a voice command. Such inputs may alter the user recording criteria definition, activate, or deactivate a recording of a specific call, insert bookmarks during a call in order to enable a later search of said bookmark, submit a replay command during a call and request special services provided by the network based recording system.

It is further appreciated that network based recording embodiments of the present invention typically provide adequate security, preferably by requiring a password for accessing a specific user account. In addition, recorded calls and related data are typically encrypted within the system.

Additionally, according to pre-determined criteria or specific requirement of a user or a group of organized users, call recordings and any related data of said users may be securely transferred from the storage facilities and databases of the network based recording system to the users preferred storage, which is typically within the users premises.

It will be appreciated by persons skilled in the art that the present invention is not limited by what has been particularly shown and described hereinabove. Rather the scope of the present invention includes both combinations and sub combinations of the various features described hereinabove as well as variations and modifications which would occur to persons skilled in the art upon reading the specification and which are not in the prior art.

1. In a mobile communications environment including a multiplicity of mobile communicators in communication with a plurality of communications centers, a communications recording system comprising:
a plurality of communications recorders located at disparate physical locations, operative to record communications involving ones of said multiplicity of mobile communicators;
a plurality of recorded communication storage facilities located at said disparate physical locations, each storage facility at a given one of said disparate physical locations being capable of storing plural recorded communications recorded by a communications recorder at said location; and
at least one recorded communication retriever operative to locate and retrieve selected ones of said plurality of stored communications from at least one of said plurality of recorded communication storage facilities in accordance with selection criteria.

2. A communications recording system according to claim 1 and wherein said at least one recorded communication retriever is also operative to supply said selected ones of said plurality of stored recorded communications to corresponding users in accordance with supply criteria.

3. A communications recording system according to claim 2 and wherein at least one participant in at least one of said recorded communications is at least one of said corresponding users.

4. A communication recording system according to claim 3 and wherein said selection criteria and said supply criteria for at least one of said stored recorded communication are determined by at least one of said corresponding users.

5. A communications recording system according to claim 4 and wherein said selection criteria and said supply criteria are pre-selected.

6. A communications recording system according to claim 1 and wherein:
said recordings of said communications are located at locations in propinquity to the location of corresponding ones of said multiplicity of communications centers.

7. A communications recording system according to claim 1 and also comprising a recording notifier operative to provide notification of recording to at least one party to said communications.

8. A communications recording system according to claim 1 and wherein said at least one network is connected to a PBX and said at least one communication recorder is operative to record communications involving said PBX.

9. In a communications environment including a multiplicity of communicators in communication with a plurality of communications centers organized into a plurality of networks, a communications recording system comprising:
at least one communication recorder operative to record communications involving ones of said multiplicity of communicators, said plurality of communication recorders are operative to record communications involving plural ones of said plurality of networks.
at least one recorded communication retriever operative to locate and retrieve selected ones of said plurality of stored communications from at least one of said plurality of recorded communication storage facilities associated with said plurality of networks in accordance with selection criteria.

10. A communications recording system according to claim 9 and also comprising a cross-network user identifier operative to identify a user irrespective of which of said at least one network the user employs to initiate said communications.

11. A communications recording system according to claim 9 and wherein said plurality of networks comprises at least one mobile network.

12. A communications recording system according to claim 9 and wherein said plurality of networks comprises at least one PSTN network.

13. A communications recording system according to claim 9 and wherein said plurality of networks comprises at least one VOIP network.

14. A communications recording system according to claim 9 and wherein at least one of said plurality of networks is connected to a PBX and said at least one communication recorder is operative to record communications of communicators connected to said PBX.

15. A communications recording system according to claim 14 and comprising a PBX extension identifier operative to identify at least one PBX extension.

16. A communications recording system according to claim 14 wherein said PBX includes a communications recording facility, said communication recording system also comprising an interface enabling communication between said communications recording facility and said at least one communication recorder.

17. In a communications environment including a multiplicity of communicators in communication with a plurality of communications centers, a communications recording system comprising:
at least one network-based communication recorder operative to record communications involving ones of said multiplicity of communicators; and
at least one communicator-based communication recorder operative to record communications involving at least one of said multiplicity of communicators in response to a first input provided by a user of said communicator.

18. A communications recording system according to claim 17 and also comprising:
a communications facility enabling transfer of recorded communications to and from said at least one communicator-based communication recorder from and to said at least one network-based communication recorder.

19. A communications recording system according to claim 17 and wherein at least one of said at least one network-based communication recorder and said at least one communicator-based communication recorder is operative to record said communication in accordance with criteria pre-selected by authorized persons associated with said ones of said multiplicity of communicators.

20. A communications recording system according to claim 17 and wherein said at least one network-based communication recorder is actuated by a second input provided by said user of said communicator.
